(19) United States
(12) Patent Application Publication
(10) Pub. No.: US 2025/0239624 A1
(43) Pub. Date: Jul. 24, 2025

(54) RADICAL SCAVENGERS, CATALYTIC STRUCTURES WITH RADICAL SCAVENGERS, AND METHODS FOR FABRICATION AND USE THEREOF

(71) Applicants: UNIVERSITY OF MARYLAND, COLLEGE PARK, College Park, MD (US); BATTELLE MEMORIAL INSTITUTE, Richland, WA (US)

(72) Inventors: Liangbing HU, Rockville, MD (US); Hua XIE, Rockville, MD (US); Yuyan SHAO, Richland, WA (US); Venkateshkumar PRABHAKARAN, Richland, WA (US)

(21) Appl. No.: 18/698,057

(22) PCT Filed: Oct. 4, 2022
(86) PCT No.: PCT/US2022/045611

§ 371 Date: Apr. 3, 2024

Related U.S. Application Data
(60) Provisional application No. 63/262,061, filed on Oct. 4, 2021.

(51) Int. Cl. H01M 4/86; H01M 4/88; H01M 4/90

(52) U.S. Cl. CPC H01M 4/8663; H01M 4/8825; H01M 4/9041

(57) ABSTRACT

A catalytic structure can comprise a catalyst and one or more radical scavengers. Each radical scavenger can comprise one or more nanoparticles. Each nanoparticle can be formed as an oxide or oxynitride and can comprise at least one metal selected from titanium (Ti), zirconium (Zr), hafnium (Hf), rutherfordium (Rf), vanadium (V), niobium (Nb), tantalum (Ta), and dubnium (Db). In some embodiments, the radical scavenger can be used in an oxygen reduction reaction, for example, to decompose hydrogen peroxide into water and oxygen. In some embodiments, the catalytic structure with radical scavengers can exhibit enhanced durability, for example, when incorporated into a proton-exchange membrane (PEM) fuel cell.

### CROSS-REFERENCE TO RELATED APPLICATION

The present application claims the benefit of U.S. Provisional Application No. 63/262,061, filed Oct. 4, 2021, entitled “Tantalum/Titanium Oxide Nanoparticles as Radical Scavengers for Durable Platinum-Group-Metal Free Oxygen Reduction Catalysts,” which is incorporated by reference herein in its entirety.

### STATEMENT REGARDING FEDERALLY SPONSORED RESEARCH

This invention was made with government support under DEAC0576RL01830 awarded by the Department of Energy (DOE). The government has certain rights in the invention.

### FIELD

The present disclosure relates generally to catalysts, and more particularly, to radical scavengers and catalytic structures with such radical scavengers, methods for fabrication and use thereof, and systems employing such catalytic structures.

### BACKGROUND

Platinum group metal-free (PGM-free) catalysts are promising alternatives to current electrocatalysts for the oxygen reduction reaction (ORR) in proton exchange membrane (PEM) fuel cells due to their reduced cost as compared to platinum-based materials. For example, PGM-free catalysts formed of transition metal and nitrogen co-doped carbon (M-N—C, where M is Fe, Co, Mn, Sn, etc.) have been proposed in view of their high catalytic activity. However, existing PGM-free catalysts face durability issues, particularly in acidic environments, in which performance rapidly decays within the first 100-hours of fuel cell operation. Such degradation has limited the adoption of PGM-free catalysts in existing fuel cell applications.

Catalytic degradation can result from production of radicals during the ORR. For example, radicals like ^{·}OH and HO₂^{·} can directly damage the active sites in PGM-free catalysts by (1) oxidation of carbon to CO₂, which can lead to the demetallation of metal active sites and/or (2) formation of oxygen functional groups, which can decrease the turnover frequency of catalysts. Additionally, the damaged M-N moieties can further lead to an increase of the H₂O₂ yield in acidic media, which can form a positive feedback loop that deteriorates catalytic performance. Although existing PGM-free catalysts may exhibit good electrocatalytic selectivity and relatively low H₂O₂ yield (e.g., under 5%), the net generation of radicals due to accumulated intermediate H₂O₂ can degrade the catalysts and impair their activity. While H₂O₂ is usually not considered as the most reactive oxygen species, under some circumstances (e.g., high temperature, acid environment, and/or Fenton reaction's conditions), H₂O₂ can decompose into ^{·}OH radicals, which are the most reactive oxygen species.

Embodiments of the disclosed subject matter may address one or more of the above-noted problems and disadvantages, among other things.

### SUMMARY

Embodiments of the disclosed subject matter system provide radical scavengers that can be used to enhance the durability of catalysts, for example, by preferentially adsorbing, deactivating, decomposing, or otherwise removing oxygen radicals that could degrade active sites of the catalyst. In some embodiments, the radical scavengers can be combined with the catalyst to form a catalytic structure, for example, for use in a proton-exchange membrane (PEM) fuel cell. In some embodiments, the radical scavenger can include one or more nanoparticles formed of oxygen and at least one metal selected from the Group IV and V elements. In some embodiments, the radical scavenger includes at least two metals selected from the Group IV and V elements, for example, to provide enhanced radical scavenging performance. For example, nanoparticles of Ta—TiOₓ can be added to a PGM-free catalyst to serve as scavengers for radicals and H₂O₂, which improves the durability of the catalyst. Embodiments of the disclosed subject matter can be applied to control the influence of H₂O₂ and its radicals in an oxygen reduction reaction (ORR), or to any other reactions or systems that involve detrimental oxygen radicals, such as but not limited to organic synthesis.

In one or more embodiments, a catalytic structure can comprise a catalyst and one or more radical scavengers. Each radical scavenger can comprise one or more nanoparticles. Each nanoparticle can be formed as an oxide or oxynitride and can include two metals. The two metals can be selected from the group consisting of titanium (Ti), zirconium (Zr), hafnium (Hf), rutherfordium (Rf), vanadium (V), niobium (Nb), tantalum (Ta), and dubnium (Db).

In one or more embodiments, a radical scavenger can be for use with a catalyst. The radical scavenger can comprise one or more nanoparticles. Each nanoparticle can be formed as an oxide or oxynitride and can comprise two metals. The two metals can be selected from the group consisting of Ti, Zr, Hf, Rf, V, Nb, Ta, and Db.

In one or more embodiments, a method can comprise performing an oxygen reduction reaction in the presence of a catalyst. The method can further comprise decomposing, via one or more radical scavengers, hydrogen peroxide (H₂O₂) into water (H₂O) and oxygen (O₂) via a disproportionation reaction. Each radical scavenger can comprise one or more nanoparticles. Each nanoparticle can be formed as an oxide or oxynitride and can comprise two metals. The two metals can be selected from the group consisting of Ti, Zr, Hf, Rf, V, Nb, Ta, and Db.

In one or more embodiments, a method can comprise providing one or more precursors on a substrate, and subjecting the one or more precursors to a thermal shock so as to convert the one or more precursors into one or more nanoparticles. Each nanoparticle can be formed as an oxide or oxynitride and can comprise two metals. The two metals can be selected from the group consisting of Ti, Zr, Hf, Rf, V, Nb, Ta, and Db. The thermal shock can include exposure to a peak temperature of at least 750 K for a duration less than or equal to 60 seconds. The one or more nanoparticles can form a radical scavenger for use with a catalyst.

Any of the various innovations of this disclosure can be used in combination or separately. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the disclosed technology will become more apparent from the following detailed description, which proceeds with reference to the accompanying figures.

### BRIEF DESCRIPTION OF THE DRAWINGS

Embodiments will hereinafter be described with reference to the accompanying drawings, which have not necessarily been drawn to scale. Where applicable, some elements may be simplified or otherwise not illustrated in order to assist in the illustration and description of underlying features. Throughout the figures, like reference numerals denote like elements.

FIG. 1A is a simplified schematic diagram of a radical scavenger formed by a plurality of oxide or oxynitride nanoparticles on a substrate, according to one or more embodiments of the disclosed subject matter.

FIGS. 1B and 1C are scanning electron microscopy (SEM) and transmission electron microscopy (TEM) images, respectively, of a radical scavenger formed by TaTiOₓ nanoparticles on a carbon substrate.

FIG. 1D is a graph of particle size distribution of TaTiOₓ nanoparticles formed on a carbon substrate.

FIG. 1E is a high-angle annular dark-field scanning transmission electron microscopy (HAADF-STEM) image of a fabricated TaTiOₓ nanoparticle in a [001]zone axis.

FIG. 1F and FIG. 2A show results of energy dispersive spectrometry (EDS) mapping and spectra, respectively, of a fabricated TaTiOₓ nanoparticle.

FIG. 2B is a graph of nitrogen (N₂) adsorption-desorption isotherms of a radical scavenger formed by a plurality of TaTiOₓ nanoparticles on a carbon substrate at 77 K, with the inset showing pore size distribution.

FIG. 2C is a graph of X-ray powder diffraction (XRD) patterns of TaTiOₓ nanoparticles fabricated with Ta:Ti ratios of 2:8, 4:6, 6:4, and 8:2.

FIGS. 3A-3B are simplified schematic diagrams of catalyst behavior during an oxygen reduction reaction without and with radical scavengers, respectively, according to one or more embodiments of the disclosed subject matter.

FIG. 4 is a simplified schematic diagram of a fuel cell employing catalyst with radical scavengers, according to one or more embodiments of the disclosed subject matter.

FIG. 5 is a process flow diagram of a method for performing an oxygen reduction reaction using radical scavengers, according to one or more embodiments of the disclosed subject matter.

FIG. 6A is a process flow diagram of a method for fabricating a catalytic structure with radical scavengers, according to one or more embodiments of the disclosed subject matter.

FIG. 6B is a graph illustrating an exemplary temperature profile for forming radical scavengers, according to one or more embodiments of the disclosed subject matter.

FIG. 6C depicts a generalized example of a computing environment in which the disclosed technologies may be implemented.

FIG. 7A shows a Stern-Volmer plot obtained using 6CFL dye in radical solution containing Fenton's reagent and Fe—N—C or Ta—TiOₓ scavengers as a function of the H₂O₂/radical quencher concentration.

FIG. 7B shows electron paramagnetic resonance (EPR) spectra of the OH-DMPO^{·} radical with and without the addition of Ta—TiOₓ/KB to the solution.

FIG. 7C shows radical concentration versus time for OH-DMPO^{·} radicals with and without the addition of Ta—TiOₓ/KB.

FIG. 8A is a graph comparing the oxygen reduction reaction (ORR) performance of Fe—N—C catalysts with and without Ta—TiOₓ/KB scavengers (10 wt %, Ta:Ti ratio of 6:4).

FIGS. 8B-8C show results of rotating ring-disk voltammetry (RRDE) durability tests for ORR performance at an initial cycle and after 10,000 (10 k) potential cycles for an Fe—N—C catalyst without and with Ta—TiOₓ/KB scavengers (10 wt %, Ta:Ti ratio of 6:4), respectively.

FIG. 8D is a graph comparing the hydrogen peroxide (H₂O₂) yield from ORR for Fe—N—C catalysts with and without Ta—TiOₓ/KB scavengers (10 wt %, Ta:Ti ratio of 6:4).

FIGS. 8E-8F show results of durability tests for H₂O₂ yield from ORR at an initial cycle and after 10 k potential cycles for Fe—N—C catalysts with and without Ta—TiOₓ/KB scavengers (10 wt %, Ta:Ti ratio of 6:4).

FIGS. 9A-9B are graphs of voltage and power density polarization, respectively, for a proton-exchange membrane (PEM) fuel cell having a Fe—N—C catalyst, with and without Ta—TiOₓ/KB scavengers, before and after accelerated durability testing (ADT) (Cathode: Fe—N—C catalyst loading of 6.0 mg/cm² (with or without scavengers). Anode: Pt/C (46.5% Pt) catalyst loading of 0.2 mg_{Pt}/cm²).

FIG. 9C compares current density decay for PEM fuel cells, with and without Ta—TiOₓ/KB scavengers, before and after ADT.

FIG. 10 is a graph of adsorption energies of H₂O₂ and related radicals on the surfaces of Fe—N—C and TaO₂—OH.

FIGS. 11A-11B show ORR performance and H₂O₂ yield, respectively, of Fe—N—C catalysts with Ta—TiOₓ nanoparticles (10 wt %) at Ta:Ti ratios of 2:8, 4:6, 6:4, and 8:2.

FIGS. 12A-12B show results of RRDE durability tests for H2O2 yield for different Fe—N—C catalyst loadings without and with Ta—TiOₓ/KB scavengers (10 wt %), respectively.

FIGS. 13A-13B show ORR performance and H₂O₂ yield, respectively, of Fe—N—C catalysts with Ta—TiOₓ/KB scavengers at different weight ratios.

### DETAILED DESCRIPTION

### General Considerations

For purposes of this description, certain aspects, advantages, and novel features of the embodiments of this disclosure are described herein. The disclosed methods and systems should not be construed as being limiting in any way. Instead, the present disclosure is directed toward all novel and nonobvious features and aspects of the various disclosed embodiments, alone and in various combinations and sub-combinations with one another. The methods and systems are not limited to any specific aspect or feature or combination thereof, nor do the disclosed embodiments require that any one or more specific advantages be present, or problems be solved. The technologies from any embodiment or example can be combined with the technologies described in any one or more of the other embodiments or examples. In view of the many possible embodiments to which the principles of the disclosed technology may be applied, it should be recognized that the illustrated embodiments are exemplary only and should not be taken as limiting the scope of the disclosed technology.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one skilled in the art.

The disclosure of numerical ranges should be understood as referring to each discrete point within the range, inclusive of endpoints, unless otherwise noted. Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person skilled in the art to have a more definitive construction, the numerical parameters set forth are approximations that may depend on the desired properties sought and/or limits of detection under standard test conditions/methods, as known to those skilled in the art. When directly and explicitly distinguishing embodiments from discussed prior art, the embodiment numbers are not approximates unless the word “about” is recited. Whenever “substantially,” “approximately,” “about,” or similar language is explicitly used in combination with a specific value, variations up to and including 10% of that value are intended, unless explicitly stated otherwise.

Directions and other relative references may be used to facilitate discussion of the drawings and principles herein but are not intended to be limiting. For example, certain terms may be used such as “inner,” “outer,” “upper,” “lower,” “top,” “bottom,” “interior,” “exterior,” “left,” right,” “front,” “back,” “rear,” and the like. Such terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” part can become a “lower” part simply by turning the object over. Nevertheless, it is still the same part, and the object remains the same.

As used herein, “comprising” means “including,” and the singular forms “a” or “an” or “the” include plural references unless the context clearly dictates otherwise. The term “or” refers to a single element of stated alternative elements or a combination of two or more elements unless the context clearly indicates otherwise.

Although there are alternatives for various components, parameters, operating conditions, etc. set forth herein, that does not mean that those alternatives are necessarily equivalent and/or perform equally well. Nor does it mean that the alternatives are listed in a preferred order, unless stated otherwise. Unless stated otherwise, any of the groups defined below can be substituted or unsubstituted.

Unless explained otherwise, all technical and scientific terms used herein have the same meaning as commonly understood to one skilled in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Features of the presently disclosed subject matter will be apparent from the following detailed description and the appended claims.

### Overview of Terms

The following is provided to facilitate the description of various aspects of the disclosed subject matter and to guide those skilled in the art in the practice of the disclosed subject matter.

Thermal shock: Application of a thermal shock temperature for a time period having a duration less than or equal to about 60 seconds, for example in a range of 1 microsecond to 10 seconds. In some embodiments, the duration of the time period of thermal shock temperature application is less than 500 milliseconds, for example, less than or equal to 100 milliseconds. For example, in some embodiments, the duration of the thermal shock can be in a range of about 10 milliseconds to about 500 milliseconds, inclusive, for example, about 100 milliseconds. In some embodiments, the thermal shock may involve heating to the thermal shock temperature at a ramp rate of at least 10³ K/s (e.g., in a range of 10³-10⁵ K/s) prior to the heating time period, and/or cooling from the thermal shock temperature at a ramp rate of at least 10³ K/s (e.g., in a range of 10³-10⁵ K/s).

Thermal shock temperature: A peak or maximum temperature at a surface of one or more heating elements when energized (e.g., by application of a current pulse) and/or at a surface of a material being heated. In some embodiments, the thermal shock temperature is at least about 750 K, for example, in a range of about 1200 K to about 3000 K, inclusive (e.g., 1500-3000 K, inclusive). In some embodiments, a temperature at a material being heated (e.g., precursors on a substrate) can match or substantially match (e.g., within 10%) the temperature of the heating element.

Particle size: A maximum cross-sectional dimension (e.g., diameter) of one or more particles. In some embodiments, an identified particle size represents an average particle size for all particles (e.g., an average of the maximum cross-sectional dimensions). In some embodiments, the particle size can be measured according to one or more known standards, such as, but not limited to, ASTM B214-16 entitled “Standard Test Method for Sieve Analysis of Metal Powders,” ASTM B330-20 entitled “Standard Test Methods for Estimating Average Particle Size of Metal Powders and Related Compounds Using Air Permeability,” ASTM B822-20 entitled “Standard Test Method for Particle Size Distribution of Metal Powders and Related Compounds by Light Scattering,” and ASTM B922-20 entitled “Standard Test Method for Metal Powder Specific Surface Area by Physical Adsorption,” all of which are incorporated by reference herein.

Nanoparticle: An engineered particle formed of a plurality of elements (e.g., at least three (3) elements) and having a maximum cross-sectional dimension (e.g., diameter when the particle is spherical) less than or equal to about 1 μm, for example, about 100 nm or less. In some embodiments, each nanoparticle has a maximum cross-sectional dimension of less than or equal to about 25 nm, for example, in a range of 1-10 nm, inclusive.

Rutile Phase: A metal oxide or metal oxynitride phase having a tetragonal unit cell crystal structure and a trigonal planar coordination for oxygen anions contained therein.

Radical Scavenger: A material that preferentially interacts with, decomposes, adsorbs, removes, and/or de-activates a free radical produced by a chemical reaction, such as a hydroxyl radical (·OH), a hydroperoxyl radical (HO₂·), and/or a precursor thereof (e.g., hydrogen peroxide (H₂O₂)). In some embodiments, the provision of one or more radical scavengers can avoid, or at least reduce, deterioration of a catalyst, for example, due to loss of catalytic active sites due to interaction with the radicals.

Platinum-group metals (PGM): The group consisting of platinum (Pt), iridium (Ir), osmium (Os), palladium (Pd), rhodium (Rh), and ruthenium (Ru).

Group IV elements: The group consisting of titanium (Ti), zirconium (Zr), hafnium (Hf), and rutherfordium (Rf).

Group V elements: The group consisting of vanadium (V), niobium (Nb), tantalum (Ta), and dubnium (Db).

### INTRODUCTION

One or more radical scavengers can be used to enhance the durability and/or performance of catalysts. The radical scavenger can be combined (e.g., mixed) with a catalyst (e.g., a platinum-group metal free (PGM-free) catalyst) to form a catalytic structure. Alternatively or additionally, in some embodiments, the radical scavenger can be provided on the catalyst or at any other location within a reactor system effective to deactivate radicals prior to impacting the catalyst. In some embodiments, the catalyst is used to control the influence of H₂O₂ and its radicals in an oxygen reduction reaction (ORR), or in any other reactions or systems that involve detrimental oxygen radicals. In some embodiments, the radical scavenger(s) can be used to improve, or at least maintain, performance of a proton-exchange membrane (PEM) fuel cell.

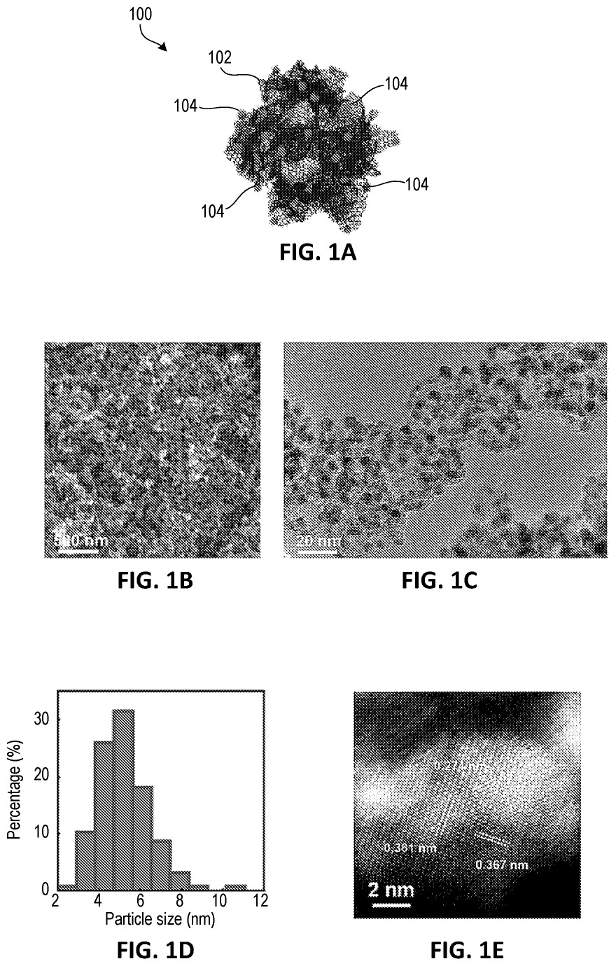

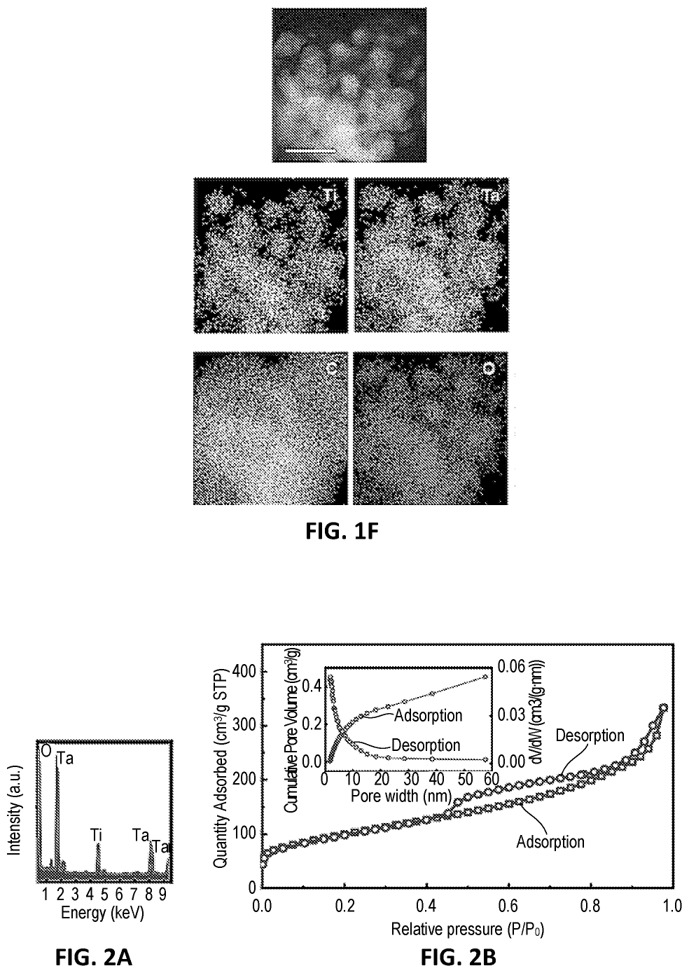

In some embodiments, the radical scavenger can include a substrate upon which nanoparticles are formed. For example, FIG. 1A shows an exemplary radical scavenger 100 having a plurality of uniformly dispersed nanoparticles 104 on a substrate 102. In the illustrated example, substrate 102 is in the shape of a particle (e.g., having a particle size ≥100 μm). Other forms for the substrate are also possible according to one or more contemplated embodiments. For example, the substrate can be in the form of a fiber (e.g., matrix or network of nanofibers), membrane, pellet (e.g., multi-lobed pellet), or any other shape or configuration. In some embodiments, substrate 102 can be formed of carbon (e.g., electro-conductive carbon particles, carbon nanofibers, carbon felt, graphene, etc.) or a ceramic (e.g., silica). In the illustrated example, substrate 102 may be an integral part of the radical scavenger 100, with the nanoparticles 104 constituting at least 50 wt % (e.g., ˜66 wt %) of the scavenger 100. In such embodiments, anchoring the nanoparticles to the substrate may help prevent their detachment and deterioration over the course of the reaction (e.g., ORR). Alternatively or additionally, in some embodiments, the substrate can be disposable (e.g., sacrificial) or removable, such that the radical scavenger is formed only by free-standing nanoparticles 104.

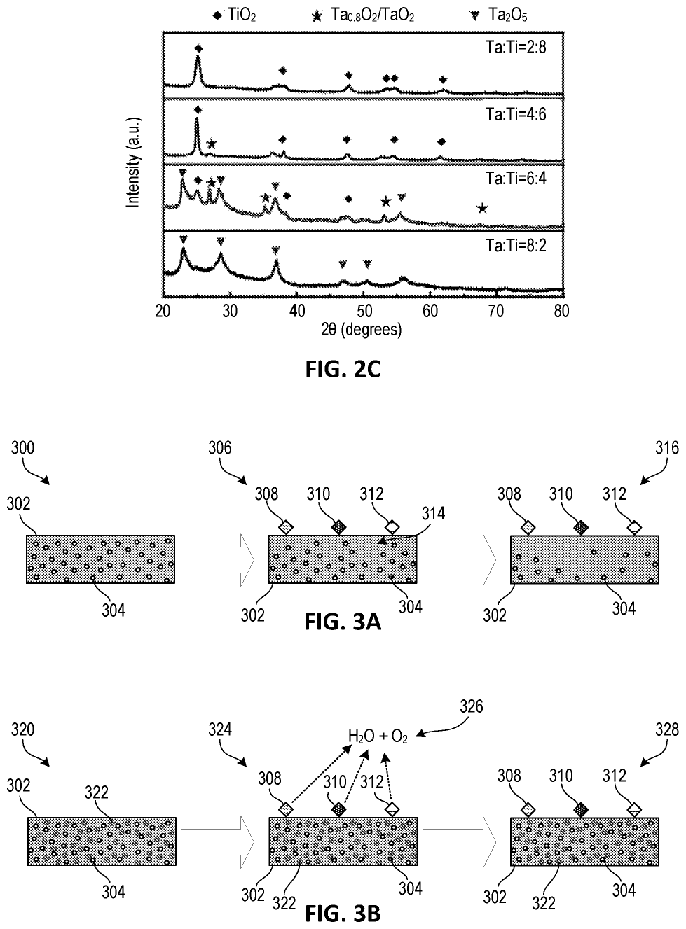

In some embodiments, the nanoparticles 104 of the radical scavenger 100 are metal oxide nanoparticles and/or metal oxynitride nanoparticles with at least one metal selected from the Group IV and V elements, for example, to achieve satisfactory radical scavenging performance. Alternatively, in some embodiments, the nanoparticles 104 of the radical scavenger 100 are metal oxide nanoparticles and/or metal oxynitride nanoparticles with at least two metals selected from the Group IV and V elements, for example, tantalum (Ta) and titanium (Ti) (e.g., TaTiOₓ nanoparticles). In some embodiments, the nanoparticles 104 can have a particle size less than 100 nm, for example, in a range of 1-10 nm (e.g., ˜5.2±1.2 nm, as shown in FIG. 1D). For example, FIGS. 1B-1C shows Ta—TiOₓ nanoparticles (Ta/Ti ratio is 6:4) formed on a Ketjenblack (KB) carbon substrate. The KB substrate can provide ample pores and surfaces to anchor the Ta—TiOₓ nanoparticles and promote their dispersion. High-angle annular dark-field scanning transmission electron microscopy (HAADF-STEM) of the TaTiOₓ nanoparticles shows lattice fringes of 0.39 nm and 0.37 nm, corresponding to the (010) and (100) planes of the solid solution structure of tantalum titanium oxide, as shown in FIG. 1E. Energy-dispersive X-ray spectroscopy (EDS) confirms uniform alloying of the Ta and Ti elements in the nanoparticles, as shown in FIGS. 1F-2A. N₂ adsorption-desorption isotherms of the KB-supported Ta—TiOₓ nanoparticles were measured at 77 K to evaluate the specific surface area of the scavengers. As shown in FIG. 2B, the material demonstrated a surface area of 312.7 m²/g (e.g., as determined by the Brunauer-Emmett-Teller (BET) method), which is consistent with the high porosity shown in the images of FIGS. 1B-1C. Such porosity and uniform dispersion can help enhance the exposure of nanoparticles to H₂O₂ and reduce the net accumulation of ^{·}OH and HO₂^{·} radicals through either efficient scavenging of radicals or chemical decomposition of H₂O₂ to water and oxygen.

In some embodiments, the composition of the nanoparticles 104 can be selected to provide a rutile phase, for example, a rutile tantalum oxide phase. For example, an atomic ratio of Ta to Ti can be in arrange of 4:6 to 8:2 (e.g., about 6:4). Nanoparticles of different Ta/Ti atomic ratios of 2:8, 4:6, 6:4, and 8:2 were fabricated by tuning the precursor loading. The powder X-ray diffraction (XRD) patterns of the resulting Ta—TiOₓ nanoparticles of FIG. 2C demonstrate the phase evolution of the different compositions. As the Ta/Ti ratio was changed from 2:8 to 8:2, the dominant crystal phase gradually evolved from a solid solution of TiO₂ (anatase structure) to Ta₂O₅. However, the Ta—TiOₓ nanoparticles with 6:4 Ta/Ti ratio resulted in a rutile TaO₂ structure (marked with asterisks). This rutile solid solution can be generated in an oxygen deficient environment (e.g., inert gas or vacuum) via a rapid temperature change (e.g., thermal shock, as described herein below) during synthesis. Rutile TaO₂ is metastable, and its surface can strongly adsorb oxygen or hydroxy groups, forming the stable cation-deficient compound Ta_{0.8}O₂, while the structure remains rutile with only minor changes of the lattice constants. X-ray photoelectron spectroscopy (XPS) analysis confirmed no discernable valence change of the Ta ions as the atomic ratios were varied. The distinct phase structures of these Ta—TiOₓ nanoparticles can present significant differences in radical scavenging capabilities.

In some embodiments, the nanoparticles can enhance the durability and/or performance of a catalyst, for example, by preferentially adsorbing, deactivating, decomposing, or otherwise removing oxygen radicals (^{·}OH, HO₂^{·}) and hydrogen peroxide (H₂O₂) that could otherwise degrade the catalyst. For example, FIG. 3A illustrates operation of a catalyst 302 without use of a radical scavenger. In some embodiments, catalyst 302 is a PGM-free catalyst, for example, carbon co-doped with a transition metal and nitrogen (N). In some embodiments, the PGM-free catalyst can be formed of carbon co-doped with N and any one of cobalt (Co), manganese (Mn), iron (Fe), tin (Sn), nickel (Ni), copper (Cu), and zinc (Zn). For example, the catalyst comprise Fe—N—C, Co—N—C, or Mn—N—C.

In its initial state 300 prior to operation, catalyst 302 includes a plurality of catalytic active sites 304. During operation 306 (e.g., during an oxygen reduction reaction), hydrogen peroxide 308 can be generated due to an incomplete oxygen reduction pathway and may decompose into hydroxyl (^{·}OH) 310 and/or hydroperoxyl 312 (HO₂^{·}) radicals. Interactions between the catalyst 302 and the generated hydrogen peroxide 308 and/or radicals 310, 312 can damage the active sites 304 in region 314, thereby leading to significant loss of active sites 304 in final state 316 after operation, reflecting degraded catalytic performance of the catalyst 302.

In contrast, the use of radical scavengers can avoid the rapid loss of catalytic active sites. For example, FIG. 3B illustrates operation of a catalytic structure formed by the combination of catalyst 302 and radical scavengers 322. In the initial state 320 prior to operation, the catalytic active sites 304 and the radical scavengers 322 can be uniformly distributed through the catalyst 302. In some embodiments, the radical scavengers 322 can be 5-20 wt % of the catalytic structure, for example, ˜10 wt %. During operation 324 (e.g., during an oxygen reduction reaction), the generated hydrogen peroxide 308, hydroxyl (^{·}OH) radicals 310, and/or hydroperoxyl (HO₂^{·}) radicals 312 can be proactively decomposed by the provided radical scavengers 322, such that the active sites 304 are preserved in the final state 328 after operation. In some embodiments, the radical scavengers 322 can decompose the molecules 308, 310, and/or 312 into products 326 (e.g., water (H₂O) and/or oxygen (O₂)), for example, via a disproportionation reaction.

### Fuel Cells Employing Radical Scavengers

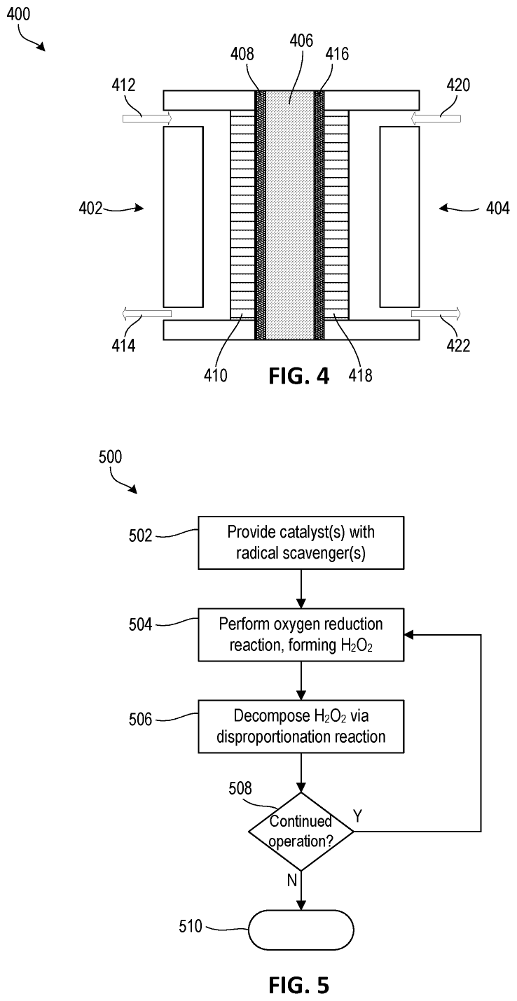

In some embodiments, a radical scavenger can be included in a fuel cell to improve operation thereof. For example, FIG. 4 shows a fuel cell 400 that employs one or more radical scavengers. In the illustrated example, fuel cell 400 includes a proton exchange membrane 406 (PEM), a first gas diffusion layer 410 disposed on an anode side 402 of the PEM 406, a second gas diffusion layer 418 disposed on a cathode side 404 of the PEM 406. The fuel cell 400 can also include a first catalyst electrode layer 408 disposed between the first gas diffusion layer 410 and the PEM 406 on the anode side 402, and a second catalyst electrode layer 416 disposed between the second gas diffusion layer 418 and the PEM 406 on the cathode side 404. Alternatively, in some embodiments, the first gas diffusion layer 410 can be integrally formed with the first catalyst electrode layer 408, and/or the second gas diffusion layer 418 can be integrally formed with the second catalyst electrode layer 416. In the illustrated example, fuel cell 400 further includes a first gas manifold on the anode side 402 of the first gas diffusion layer 410 and a second gas manifold on the cathode side 404 of the second gas diffusion layer 418. Alternatively, in some embodiments, the first gas diffusion layer 410 can be integrally formed with the first gas manifold, and/or the second gas diffusion layer 418 can be integrally formed with the second gas manifold. The first gas manifold can define and/or have an inlet 412 for fuel (e.g., H₂ input) and/or an outlet 414 for unused fuel (e.g., for recirculation), while the second gas manifold can define and/or have an inlet 420 (e.g., for oxygen input) and/or an outlet 422 (e.g., for air and water output).

In some embodiments, one or more radical scavengers can be combined with a catalyst in one or both of the catalyst electrode layers. For example, the catalyst of the first catalyst electrode layer 408 on the anode side 402 of the PEM 406 can be formed of a platinum-group metal (PGM), and the catalyst of the second catalyst electrode layer 416 on the cathode side 404 of the PEM 406 can be PGM or PGM-free. Alternatively, in some embodiments, catalysts in both the first and second catalyst electrode layers can be PGM-free. The radical scavenger(s) can be formed on a surface of the first catalyst electrode layer 408 (e.g., facing PEM 406) and/or on a surface of the second catalyst electrode layer 416. Alternatively or additionally, the radical scavenger(s) can be formed as part of the catalyst electrode layer 408 and/or catalyst electrode layer 416, for example, mixed within or among the catalyst. Alternatively or additionally, the radical scavenger(s) can be formed on a surface of the PEM 406, as part of the PEM (e.g., within a membrane layer), and/or at any other useful location for removing radical. In some embodiments, the provision of radical scavenger(s) can enhance performance of the fuel cell, for example, by preserving active sites within the catalyst(s) of the first catalyst electrode layer 408 and/or the catalyst(s) of the second catalyst electrode layer 416.

### Oxygen Reduction Reaction Methods

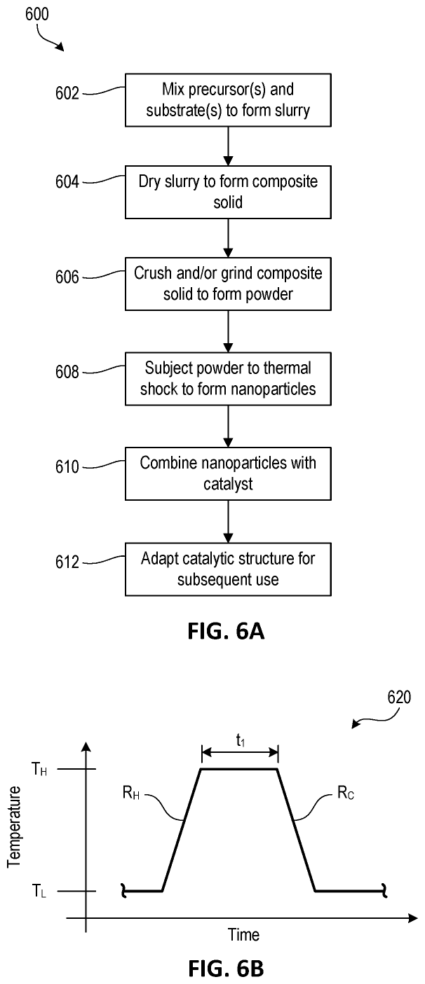

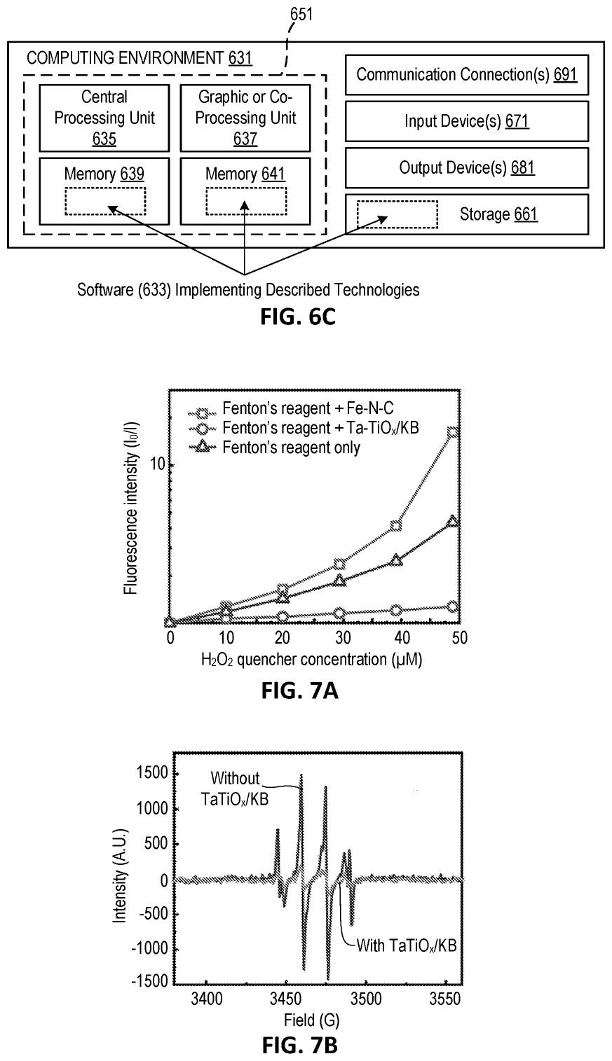

FIG. 5 illustrates a method 500 for performing an oxygen reduction reaction using radical scavengers. The method 500 can initiate at process block 502, where one or more catalytic structures can be provided. Each catalytic structure can be formed of one or more catalysts with one or more radical scavengers. Each radical scavenger can be formed of one or more nanoparticles, optionally with one or more substrate(s). As discussed above, each nanoparticle can be formed of metal oxide or metal oxynitride, with at least one metal selected from Group IV and V elements, so as to provide a desired radical scavenging performance. In some embodiments, each nanoparticle can be formed with at least two metals selected from the Group IV and V elements. For example, each nanoparticle can be formed of TaTiOₓ with an atomic ratio of Ta to Ti in a range of 4:6 to 8:2. In some embodiments, the provision of process block 502 can include forming the catalytic structure, for example, as described in method 600 of FIG. 6A below. In some embodiments, previously fabricated catalyst(s) and radical scavenger particles can be mixed together and cast to form a composite as the catalytic structure. Alternatively, in some embodiments, radical scavengers can be coated, deposited, or otherwise loaded onto and/or within previously-formed catalyst(s), for example, by dip coating, spraying, painting, etc.

The method 500 can proceed to process block 504, where an oxygen reduction reaction (ORR) is performed using the catalyst of the catalytic structure. In some embodiments, the ORR can be part of operation of a PEM fuel cell. Due to the incomplete reduction of O₂ in the ORR, hydrogen peroxide (H₂O₂) can be generated, which can in turn yield oxygen radicals that would degrade operation of the catalyst. Alternatively, in some embodiments, the reaction of process block 504 can be any reaction in which oxygen radicals are produced, such as organic synthesis reactions or fuel cell recovery procedures.

The method 500 can proceed to process block 506, where at least some of the generated hydrogen peroxide and radicals formed therefrom (e.g., ^{·}OH and HO₂^{·} radicals) can be removed or deactivated, at least with respect to compromising active sites of the catalyst, by interaction with the radical scavenger. In some embodiments, the hydrogen peroxide and radicals formed therefrom can be decomposed by the radical scavenger into water and oxygen, for example, via a disproportionation reaction. For example, in some embodiments, the use of radical scavenger(s) can result in a yield of hydrogen peroxide that is less than or equal to 2% (e.g., as measured by a rotation ring disk electrode system).

The method 500 can proceed to decision block 508, where it is determined if the operation should continue. In some embodiments, process blocks 504-506 can be ongoing and/or simultaneous, for example, during continuous operation of a fuel cell. Thus, if continued operation is desired, the method 500 can return from decision block 508 to process block 504 for repetition. Otherwise, if continued operation is not desired, for example, due to depletion of a fuel source, periodic downtime, required maintenance, or any other reason, the method 500 can proceed from decision block 508 to terminal block 510, where the method can terminate.

Although illustrated separately, it is contemplated that various process blocks may occur simultaneously or iteratively. Indeed, hydrogen peroxide deactivation of process block 506 can occur simultaneously with, or at least overlapping, hydrogen peroxide generation during ORR of process block 504. Furthermore, certain process blocks illustrated as occurring after others may indeed occur before. Although some of blocks 502-510 of method 500 have been described as being performed once, in some embodiments, multiple repetitions of a particular process block may be employed before proceeding to the next decision block or process block. In addition, although blocks 502-510 of method 500 have been separately illustrated and described, in some embodiments, process blocks may be combined and performed together (simultaneously or sequentially). Moreover, although FIG. 5 illustrates a particular order for blocks 502-510, embodiments of the disclosed subject matter are not limited thereto. Indeed, in certain embodiments, the blocks may occur in a different order than illustrated or simultaneously with other blocks. In some embodiments, method 500 may comprise only some of blocks 502-510 of FIG. 5.

### Catalytic Structure Fabrication Methods

FIG. 6A illustrates a method 600 for fabricating a catalytic structure with radical scavengers. The method 600 can initiate at process block 602, where one or more nanoparticle precursors can be loaded onto and/or combined with one or more substrates. In some embodiments, the precursors can include at least one metal selected from Group IV and V elements, for example, to achieve a desired radical scavenging performance. Alternatively, in some embodiments, the precursors can include at least two metals selected from Group IV and V elements. For example, when the radical scavenger is formed of TaTiOx nanoparticles, the precursors can comprise titanium isopropoxide (Ti(OⁱPr)₄) and tantalum ethoxide (Ta(OEt)₅). The loading of precursors can mirror the desired composition of the nanoparticle, for example, such that a desired ratio of Ta to Ti is obtained. However, evaporation of elements can occur during the thermal shock heating phase. Accordingly, in some embodiments, the content of loaded precursors can be adjusted (e.g., increased) to compensate for any elemental loss and to achieve a desired nanoparticle composition. In some embodiments, the substrate can be formed of carbon (e.g., graphene, carbon felt, carbon nanofibers, or carbon particles, such as Ketjenblack) or a ceramic (e.g., silica particles).

In some embodiments, the nanoparticle precursor(s) can be combined with the substrate(s) by mixing, for example, to form a slurry. Alternatively or additionally, the nanoparticle precursors can be coated, deposited, infiltrated, impregnated, or otherwise provided on surface(s) of the substrate(s). For example, the precursor loading can include dip coating, brushing, spraying, printing, rolling, incipient wetness spray impregnation, agitated drying, or any combination of the foregoing.

The method 600 can proceed to process block 604, where the combination (e.g., slurry) of the substrate(s) and precursors(s) may optionally be dried, for example, to remove solvent therefrom. In some embodiments, the drying can be controlled to avoid agglomeration, detachment, and/or precipitation of the precursors, for example, to enhance or ensure a uniform precursor distribution. In some embodiments, the combination can be dried via freeze-drying or critical point drying. Alternatively, in some embodiments, the combination dried via any other drying modality, such as ambient air drying, oven drying, microwave drying, etc.

The method 600 can proceed to process block 606, where the combination (e.g., dried slurry) of the substrate(s) and precursor(s) may optionally be mechanically processed into smaller particles. For example, in some embodiments, the combination can be subjected to crushing and/or grinding, for example, to form a powder of substrate particles (e.g., having a particle size ≤1 mm) having precursor(s) thereon and/or therein.

The method 600 can proceed to process block 608, where the combination (e.g., powder) of the substrate(s) and precursor(s) can be subject to thermal shock heating. In some embodiments, the thermal shock heating can be performed in an inert environment (e.g., inert gas such as argon (Ar), nitrogen (N), or both) or under vacuum (e.g., a pressure less than or equal to 10⁻³ Torr). In some embodiments, the thermal shock heating can be achieved by a pulsed heating profile 620, with (i) a rapid heating ramp R_{H} (e.g., ≥10³ K/s, such as 10⁴-10⁵ K/s, inclusive), (ii) a short dwell period, ti (e.g., 60 s or less, such as in a range of 10 μs to 500 ms), at or about peak temperature T_{H} (e.g., ≥750 K, such as ≥1200 K, for example, in a range of 1500-3000 K), and (iii) a rapid cooling ramp R_{C} (e.g., ≥10³ K/s, such as 10⁴-10⁶ K/s, inclusive), for example, as shown in FIG. 6B. Alternatively, in some embodiments, the thermal shock 608 may be performed more than once (e.g., by subjected to multiple pulsed temperature profiles).

In some embodiments, the temperature profile 620 can provide a rapid transition to and/or from the peak temperature T_{H}, for example, from/to a low temperature T_{L}, such as room temperature (e.g. 20-25° C.) or an elevated ambient temperature (e.g., 100-200° C.)). In some embodiment, the heating of the thermal shock process can be provided by Joule heating. For example, the Joule heating can be similar to any of the systems or configurations disclosed in U.S. Publication No. 2018/0369771, published Dec. 27, 2018 and entitled “Nanoparticles and systems and methods for synthesizing nanoparticles through thermal shock,” U.S. Publication No. 2019/0161840, published May 30, 2019 and entitled “Thermal shock synthesis of multielement nanoparticles,” International Publication No. WO 2020/236767, published Nov. 26, 2020 and entitled “High temperature sintering systems and methods,” International Publication No. WO 2020/252435, published Dec. 17, 2020 and entitled “Systems and methods for high temperature synthesis of single atom dispersions and multi-atom dispersions,” and International Publication No. WO 2022/204494, published Sep. 29, 2022 and entitled “High temperature sintering furnace systems and methods,” each of which is incorporated herein by reference. Alternatively or additionally, in some embodiments, the heating of the thermal shock process can be provided by microwave heating, laser heating, electron beam heating, spark discharge heating, or any other heating mechanism capable of providing the peak temperature, heating rate, and/or cooling rate.

In some embodiments, the cooling defining the end of the thermal shock can be effected by conveying the substrates out of a heating zone and/or by de-activating, de-energizing, or otherwise terminating operation of the heating elements. Alternatively or additionally, in some embodiments, the cooling at the end of a heating pulse can be achieved using one or more passive cooling features (e.g., heat sinks thermally coupled to the heating element and/or substrate, etc.), one or more active cooling features (e.g., fluid flow directed at the substrate and/or the heater, fluid flow through a heat sink thermally coupled thereto, etc.), or any combination thereof. In some embodiments, the peak temperature can be sufficient to melt the constituent precursors and/or induce high temperature mixing, while the rapid cooling at the end of the heating pulse can enable crystallization of liquid materials into the desired nanoparticle compositions without being subjected to aggregation, agglomeration, element segregation, or phase separation.

The nanoparticles produced by the thermal shock process can have a size less than 100 nm, for example, in a range of 1-10 nm (e.g. ˜5 nm). In some embodiments, the nanoparticles are formed of a metal oxide or metal oxynitride that include at least one metal selected from Group IV and V elements. Alternatively, in some embodiments, the nanoparticles are formed of a metal oxide or metal oxynitride that include at least two metals selected from Group IV and V elements. In some embodiments, the two metals are Ta and Ti, and the nanoparticles are TaTiOₓ. In some embodiments, an atomic ratio of Ta to Ti in the nanoparticles can be in a range of 4:6 to 8:2. In some embodiments, the atomic ratio of Ta to Ti is selected such that the resulting nanoparticle provides a rutile tantalum oxide phase, for example, a Ta:Ti ratio of approximately 6:4. In some embodiments, the radical scavenger is formed by the nanoparticles on and/or within the substrate. For example, the nanoparticles can form at least 50 wt % of the radical scavenger. Alternatively, in some embodiments, the substrate can be removed (e.g., via sacrificial etching or dissolving) to yield free-standing nanoparticles as the radical scavenger (e.g., nanoparticles form 100 wt % of the radical scavenger).

The method 600 can proceed to process block 610, where the radical scavenger(s) can be loaded onto and/or combined with one or more catalysts to form a catalytic structure. In some embodiments, the catalyst can be a PGM-free catalyst, for example, carbon co-doped with nitrogen and any of cobalt, manganese, iron, tin, nickel, copper, and zinc (e.g., Fe—N—C, Co—N—C, or Mn—N—C). Alternatively, in some embodiments, the catalyst can be a PGM catalyst. In some embodiments, the loading can be such that the radical scavenger(s) are 5-20 wt % (e.g., ˜10 wt %) of the final catalytic structure and/or the catalyst(s) are 80-95 wt % of the final catalytic structure. In some embodiments, the radical scavenger(s) can be combined with the catalyst(s) by mixing, for example, to form a slurry or powder mixture. Optionally, the catalyst(s) and/or the radical scavenger(s) (e.g., if not previously pulverized at process block 606) can be subjected to crushing and/or grinding to form the powder. In some embodiments, the mixture can be cast, pressed, and/or dried to form the final catalytic structure. Alternatively, in some embodiments, the radical scavenger(s) can be coated onto the catalyst(s) to form the catalytic structure. Other methods for loading the radical scavenger(s) onto and/or combining with the catalyst(s) to form the catalytic structure are also possible according to one or more contemplated embodiments.

The method 600 can proceed to process block 612, where the catalytic structure can be used or otherwise adapted for subsequent use. In some embodiments, the catalytic structure can be used in an oxygen reduction reaction, for example, as described above with respect to FIG. 5. Alternatively or additionally, in some embodiments, the catalytic structure can be assembled for use in a fuel cell (e.g., as shown in FIG. 4), for example, by coupling the catalytic structure to or forming as part of an electrode layer or PEM.

Although illustrated separately, it is contemplated that various process blocks may occur simultaneously or iteratively. Furthermore, certain process blocks illustrated as occurring after others may indeed occur before. Although some of blocks 602-612 of method 600 have been described as being performed once, in some embodiments, multiple repetitions of a particular process block may be employed before proceeding to the next decision block or process block. In addition, although blocks 602-612 of method 600 have been separately illustrated and described, in some embodiments, process blocks may be combined and performed together (simultaneously or sequentially). Moreover, although FIG. 6A illustrates a particular order for blocks 602-612, embodiments of the disclosed subject matter are not limited thereto. Indeed, in certain embodiments, the blocks may occur in a different order than illustrated or simultaneously with other blocks. In some embodiments, method 600 may comprise only some of blocks 602-612 of FIG. 6A.

### Computer Implementation

FIG. 6C depicts a generalized example of a suitable computing environment 631 in which the described innovations may be implemented, such as but not limited to aspects of method 500, aspects of method 600, a controller of fuel cell 400, and/or a controller of a chemical reaction system. The computing environment 631 is not intended to suggest any limitation as to scope of use or functionality, as the innovations may be implemented in diverse general-purpose or special-purpose computing systems. For example, the computing environment 631 can be any of a variety of computing devices (e.g., desktop computer, laptop computer, server computer, tablet computer, etc.).

With reference to FIG. 6C, the computing environment 631 includes one or more processing units 635, 637 and memory 639, 641. In FIG. 6C, this basic configuration 651 is included within a dashed line. The processing units 635, 637 execute computer-executable instructions. A processing unit can be a central processing unit (CPU), processor in an application-specific integrated circuit (ASIC), or any other type of processor (e.g., hardware processors, graphics processing units (GPUs), virtual processors, etc.). In a multi-processing system, multiple processing units execute computer-executable instructions to increase processing power. For example, FIG. 6C shows a central processing unit 635 as well as a graphics processing unit or co-processing unit 637. The tangible memory 639, 641 may be volatile memory (e.g., registers, cache, RAM), non-volatile memory (e.g., ROM, EEPROM, flash memory, etc.), or some combination of the two, accessible by the processing unit(s). The memory 639, 641 stores software 633 implementing one or more innovations described herein, in the form of computer-executable instructions suitable for execution by the processing unit(s).

A computing system may have additional features. For example, the computing environment 631 includes storage 661, one or more input devices 671, one or more output devices 681, and one or more communication connections 691. An interconnection mechanism (not shown) such as a bus, controller, or network interconnects the components of the computing environment 631. Typically, operating system software (not shown) provides an operating environment for other software executing in the computing environment 631, and coordinates activities of the components of the computing environment 631.

The tangible storage 661 may be removable or non-removable, and includes magnetic disks, magnetic tapes or cassettes, CD-ROMs, DVDs, or any other medium which can be used to store information in a non-transitory way, and which can be accessed within the computing environment 631. The storage 661 can store instructions for the software 633 implementing one or more innovations described herein.

The input device(s) 671 may be a touch input device such as a keyboard, mouse, pen, or trackball, a voice input device, a scanning device, or another device that provides input to the computing environment 631. The output device(s) 671 may be a display, printer, speaker, CD-writer, or another device that provides output from computing environment 631.

The communication connection(s) 691 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, radio-frequency (RF), or another carrier.

Any of the disclosed methods can be implemented as computer-executable instructions stored on one or more computer-readable storage media (e.g., one or more optical media discs, volatile memory components (such as DRAM or SRAM), or non-volatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or any other such network) using one or more network computers.

For clarity, only certain selected aspects of the software-based implementations are described. Other details that are well known in the art are omitted. For example, it should be understood that the disclosed technology is not limited to any specific computer language or program. For instance, aspects of the disclosed technology can be implemented by software written in C++, Java™, Python®, and/or any other suitable computer language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means. In any of the above-described examples and embodiments, provision of a request (e.g., data request), indication (e.g., data signal), instruction (e.g., control signal), or any other communication between systems, components, devices, etc. can be by generation and transmission of an appropriate electrical signal by wired or wireless connections.

### Fabricated Examples and Experimental Results

Highly active and durable PGM-free catalysts (e.g., Fe—N—C) for the ORR can be used to lower the cost of PEM fuel cells. However, the durability of PGM-free catalysts can be impaired by the attack of oxidizing radicals such as ·OH and HO₂· that form via H₂O₂ from incomplete reduction of O₂. In some embodiments, TaTiOₓ nanoparticle additives can be used to protect Fe—N—C catalysts from such degradation via radical scavenging. For example, TaTiOₓ nanoparticles (e.g., ˜5 nm diameter) were uniformly synthesized on a Ketjenblack (carbon) substrate using a thermal shock technique. Precursors of titanium (IV) isopropoxide (Ti(OiPr)₄) and tantalum (V) ethoxide (Ta(OEt)₅) were mixed (at Ta:Ti ratios of 2:8, 4:6, 6:4, and 8:2) with the carbon substrate (Ketjenblack, carbon nanofibers, or MOF carbon) in 20 mL vials (the final weight ratio between oxides and carbon was 6:4). 10 mL of absolute ethanol and 1 mL of deionized (DI) water were added to the vials and subsequently sonicated to form a slurry mixture. The slurry was then freeze-dried for over 24 hours at −47° C. and 1.8 Pa.

After freeze-drying, the mixture was crushed into powder and transferred to the high-temperature heating element in a glovebox under Ar atmosphere. The heating element was made from carbon paper (30 mm×5 mm×2 mm in size), which was glued to copper electrodes with silver paste. A power supply was connected to the electrode to provide power (current in a range of 0-20 A and voltage in a range of 0-60 V) to the electrodes to effect transient Joule heating. To ensure heating homogeneity, the powders were uniformly spread across the surface of the heating element to a thickness of 1 mm. The powder was subjected to a fast high-temperature treatment (˜1500 K) by Joule heating the sample in an argon environment for 100 ms and then quenching the reaction by cooling at a rate of 10⁵ K/s.

To quantitively determine the radical scavenging efficacy of the as-prepared Ta—TiOₓ/KB (Ta/Ti ratio of 6:4), an ex-situ fluorescence spectrometer was used to monitor for changes in radical concentration. An Fe—N—C catalyst was synthesized via pyrolysis of a Fe-containing zeolitic imidazolate framework (ZIF-8) to serve as a representative PGM-free catalyst. In particular, the Fe—N—C catalyst was synthesized in three steps. First, Fe(acac)₃@ZIF-8 was synthesized. 2-methylimizadole (3.94 g) was dissolved in 100 ml methanol in flask A. Zn(NO₃)₂·6H₂O (3.57 g) and Fe(acac)₃ (5.0 g) were dissolved in 100 ml methanol under ultrasound for 1 hour to form a clear solution in flask B. Flask B was subsequently added into flask A with vigorous stirring (25° C.) for 24 hours. The obtained precipitant was separated by filtration and washed 3 times with methanol and finally overnight dried at 100° C. under vacuum. Second, Fe(mIm)₄@ZIF-8 precursor was synthesized. A dispersion of 1.0 g Fe(acac)₃ZIF-8, 1.0 g mIm, and 100 ml methanol was heated to 140° C. (4 hours) in a Teflon-lined autoclave. After natural cooling down, the obtained material (Fe(mIm)₄@ZIF-8) was separated by filtration and washed 3 times with methanol and finally overnight dried at 100° C. under vacuum. Third, Fe—N—C catalyst was synthesized. The powder of Fe(acac)₃@ZIF-8 precursor was transferred to a high-alumina rectangular tray and placed in the middle of a tube furnace. The furnace was heated to 1000° C. with a ramping rate of 5° C./minute and kept at 1000° C. for 1 hour under flowing Ar gas and naturally cooled to room temperature. The resulting PGM-free catalyst mainly contains atomically dispersed active centers with a small amount of Fe-carbide side phase, according to Mössbauer measurements.

The radical scavenging efficacy of the as-prepared ORR catalysts (Fe—N—C and Ta—TiOₓ) was evaluated using a custom-built fluorescence spectrometer. 6-carboxy fluorescein (6CFL) dye, which is sensitive to radicals and degrade under their attack, was used as a fluorescence molecular probe. In a typical experiment, a solution containing 1 mL of 50 μM 6CFL in DI water, 1 mM Co(NO₃)₂, and 0.5 mg of Fe—N—C or Ta—TiOₓ/KB was prepared. The 6CFL fluorescent dye was excited using a 488 nm pigtailed laser through a 300-700 nm bifurcated optical probe dipped into the solution. The emitted light was collected through the bifurcated optical probe and filtered using a long pass filter with a cut-on wavelength of 500 nm. The radicals were then generated as aliquots of hydrogen peroxide (H₂O₂) were added to the solution. The change in fluorescence of 6CFL at 544 nm relative to the initial intensity was measured using the bifurcated optical probe under constant stirring. After each addition of H₂O₂, the solution was continuously stirred for 5 minutes to allow enough time for the oxidative degradation of the dye to complete before the stable fluorescence signal was collected.

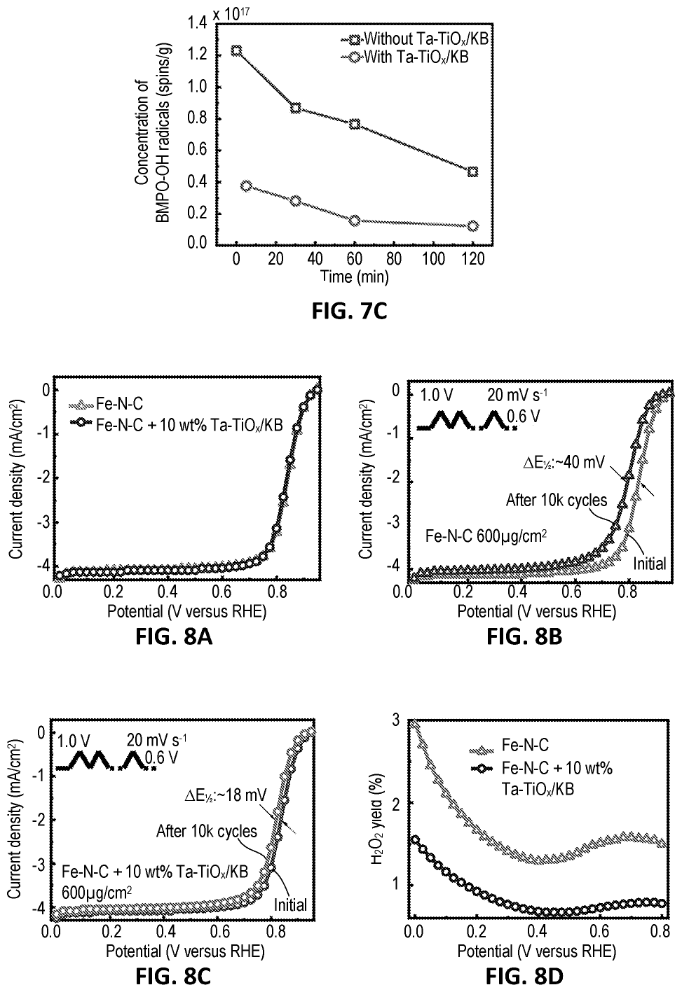

The 6CFL fluorescence decay was compared after adding only Fenton's reagent, Fenton's reagent/Fe—N—C, and Fenton's reagent/Ta—TiOₓ scavengers, respectively. The Stern-Volmer plot of FIG. 7A indicates a significantly higher fluorescence decay of 6CFL for the scenario with only Fenton's reagent or Fenton's reagent/Fe—N—C compared to the measurement with Fenton's reagent/Ta—TiOₓ. The decreased fluorescence decay of the Fenton's reagent/Ta—TiOₓ sample can be attributed to the higher radical scavenging ability of the Ta—TiOₓ nanoparticles, which decreases the oxidation of the 6CFL molecular probe. These results demonstrate that Ta—TiOₓ/KB presents high efficiency at scavenging generated radicals compared to Fe—N—C.

Electron paramagnetic resonance (EPR) spin trapping measurements were also conducted to experimentally demonstrate the scavenging capability of the Ta—TiOₓ for ^{·}OH radicals with 5,5-dimethyl-1-pyrroline-N-oxide (DMPO) as the spin trap. An X-band Bruker EMX EPR spectrometer was used for the EPR measurements. Field-swept spectra were taken in the magnetic field from 3250 to 3750 G and are representative of four scan averages collected to achieve high signal resolution. The following instrument parameters were used: microwave power=5.0 mW; modulation frequency=100 kHz; modulation amplitude=1.00 G; conversion time=40.96 ms; time constant=20.48 ms. Samples were transferred to glass capillary tubes with a 1 mm outer diameter (OD) and then placed in the EPR cavity. All measurements were done at room temperature. 2,2-Diphenyl-1-picrylhydrazyl hydrate (DPPH) was used as a solid-state standard field/frequency calibration of the EPR spectra (g_{DPPH}=2.0036±0.0003). The instrument was calibrated before each measurement by running the DPPH standard at the conditions shown above.

The data were processed by the instrument software to determine the radical concentration. The following equation was used to calculate the radical concentration, in terms of the number of spins per gram of the sample:

$$[ x ] = \frac{[ std ] {A}_{x} {{R}_{x} ( {scan}_{x} )}^{2} {G}_{std} {{{M}_{std} ( {g}_{std} )}^{2} [ s ( s + 1 ) ]}_{std}}{{A}_{std} {{R}_{std} ( {scan}_{std} )}^{2} {G}_{x} {{{M}_{x} ( {g}_{x} )}^{2} [ s ( s + 1 ) ]}_{x}} ,$$

where [ ] is the radical concentration (spins/g), A is the area under the absorption curve, R is the degeneracy of the spectrum, G is the gain of the signal amplifier (Hz), M is the modulation amplitude (G), scan is the sweep width of the measurement (G), g is the g-value of the radical measured, and s is the electron spin quantum number.

Fenton's reagent was used to generate the hydroxyl (^{·}OH) radicals, and 5,5-dimethyl-1-pyrroline-N-oxide (DMPO) was employed as a spin trapping agent to identify the ^{·}OH radical. Experiments were conducted with H₂O₂[9 M], FeSO₄ (iron source), DMPO [100 mM], and H₂SO₄. Fenton reactions were performed by mixing the reagents in the following order: DI water, H₂O₂, DMPO, and FeSO₄, and adjusting the pH to ˜3 with sulfuric acid. The experiments were conducted first without and then with the Ta—TiOₓ scavengers. Immediately after mixing the reagents mentioned and starting the reaction, a capillary tube was used to measure the sample in the EPR. The measurements were repeated after 30 minutes, 1 hour, 2 hours, and 3 hours. The same procedure was followed with the addition of the scavengers. In this case, the scavengers were added before the DMPO.

FIG. 7B shows the EPR spectra of OH-DMPO^{·} in the absence and presence of Ta—TiOₓ/KB. The electron paramagnetic resonance peak intensity with Ta—TiOₓ/KB is significantly decreased in comparison to that without Ta—TiOₓ/KB. In addition, despite the decrease in [OH-DMPO^{·}], there is no change in the hyperfine structure of the EPR spectrum. This strongly suggests that the ^{·}OH radicals are scavenged by Ta—TiOₓ. Additionally, the concentration (in spin per gram) of the OH-DMPO^{·} adduct in the Fenton's reagent was measured with and without the addition of Ta—TiOₓ/KB. FIG. 7C shows the decay kinetics of the OH-DMPO^{·} as a function of time with and without Ta—TiOₓ/KB. Notably, there is a low concentration of [OH-DMPO^{·}] in the presence of the Ta—TiOₓ radical scavengers, in which the process well fits a second-order decay.

The electrocatalytic behavior of the Ta—TiOₓ scavengers in the presence of the Fe—N—C catalyst was characterized to evaluate their H₂O₂ and radical removing ability in the oxygen reduction process. The Fe—N—C catalyst and Ta—TiOₓ/KB were mixed to form an ink and deposited on a rotating ring-disk electrode (RRDE). In particular, the tests were performed in a three-electrode setup at an electrochemical workstation using a graphite rod as the counter electrode and a reversible hydrogen electrode (RHE) reference electrode. To prepare the working electrode, 10 mg of catalyst (or 90 wt % catalyst+10 wt % TaTiOₓ/KB) was mixed with a 1990 μL mixture of isopropyl alcohol (70%)/water (30%) and 10 μL of 5 wt % Nafion™ solution by sonication for 30 min to form an ink. Then, 30 μL of the ink was drop-dried onto the RDDE to cover an area of 0.2472 cm² (i.e., a catalyst loading of ˜0.6 mg/cm²). The catalytic activity for ORR was tested by steady-state measurement using staircase potential control with a step of 0.025 V at intervals of 25 seconds from 0.0 to 1.0 V versus RHE in O₂ saturated 0.5 M H₂SO₄ solution at room temperature and a rotation rate of 900 rpm. The selectivity (four electron path) of the catalyst during the ORR was determined by measuring the ring current for calculating H₂O₂ yield. Cyclic voltammetry (CV) cycles between potential of 0.6 and 1.0 V versus RHE in O₂ saturated 0.5 M H₂SO₄ solution were performed to evaluate the ORR catalytic stability.

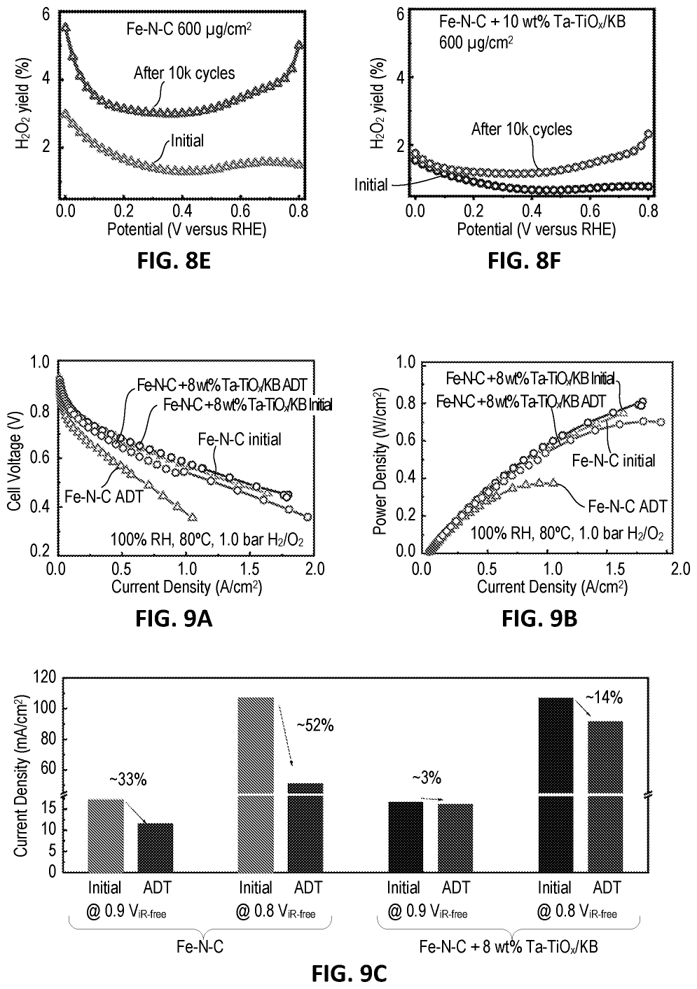

After deposition of the ink on the RRDE, a potential of 1.3 V (versus the RHE) was applied on the ring electrode in O₂-saturated 0.5 M H₂SO₄ electrolyte to quantitatively capture the relative H₂O₂ yield. FIG. 8A shows the ORR activity of the Fe—N—C catalyst with and without 10 wt % of the scavengers, synthesized at a Ta/Ti ratio of 6:4, and FIG. 11A shows the ORR activity of the Fe—N—C catalyst with and without 10 wt % of the scavengers, synthesized at a Ta/Ti ratios of 2:8, 4:6, 6:4, and 8:2 (note that do overlap in performances, only the ratios of 2:8 and 6:4 can be specifically labeled in FIG. 11A). The RRDE test revealed a half-wave potential of 0.84 V (versus RHE) for the Fe—N—C catalyst without the scavengers, showing a well-defined mass-transport limiting current density. The introduction of the 10 wt % Ta—TiOₓ/KB at a Ta/Ti ratio of 6:4 initially presents no discernable influence on the catalytic activity, which indicates the material's good compatibility with the Fe—N—C catalyst. The electrocatalytic activity was not influenced by the introduction of the nanoparticles with these Ta/Ti ratios.

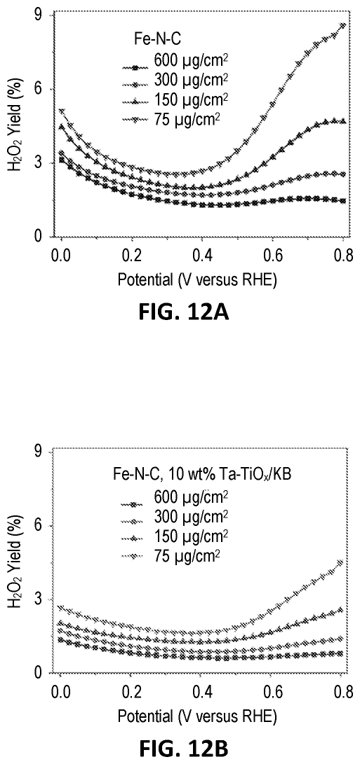

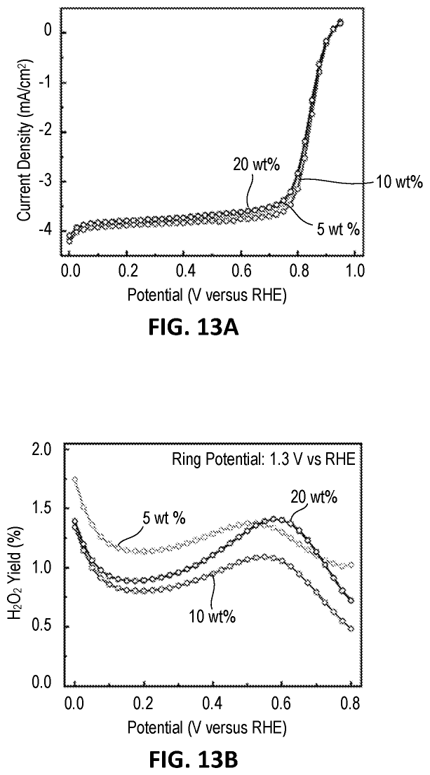

FIG. 8D shows the H₂O₂ yield with and without 10 wt % Ta—TiOₓ/KB at a Ta/Ti ratio of 6:4. The initial H₂O₂ yield for the Fe—N—C catalyst without Ta—TiOₓ/KB was ˜1.6% at an electrode potential 0.7 V (versus RHE). The relatively low H₂O₂ yield was attributed to the high catalytic efficiency of the Fe—N₄ moieties in the catalyst, which feature a high average electron-transfer number per O₂ molecule (nₑ). The H₂O₂ yield presented a gradual increase with the decrease of Fe—N—C catalyst loading from 0.600 to 0.075 mg/cm², as shown in FIGS. 12A-12B. After the introduction of the Ta—TiOₓ/KB, the H₂O₂ yielded from the catalysts displayed a pronounced decrease that was strongly dictated by the Ta/Ti composition ratio, as shown in FIGS. 8D, 11B, and 12A-12B. The Ta—TiOₓ scavengers synthesized with a Ta/Ti ratio of 6:4 provide the lowest H₂O₂ yield (around 0.88% at 0.7 V), indicating the highest H₂O₂ removal capability, likely due to the formed Ta_{0.8}O₂/TaO₂ solid solution. In contrast, other compositions present different H₂O₂ removal capabilities with a H₂O₂ yield of 1.3-1.7%. Note that this high scavenging capability corresponds with the rutile tantalum oxide that was formed at the 6:4 ratio, as shown in the XRD results. The Ta—TiOₓ/KB content was also varied from 5 wt % to 20 wt % of the Fe—N—C catalyst to evaluate the influence of scavenger loading on the scavenging ability, the results of which are shown in FIGS. 13A-13B. At 10 wt % Ta—TiOₓ/KB, the activity is slightly higher than that with 5 wt % and 20 wt % Ta—TiOₓ/KB, as shown in FIG. 13A. At 10 wt % loading, the material demonstrated optimal H₂O₂ removal efficiency (0.7% H₂O₂ yield at 0.7 V). As shown in FIG. 13B, the H₂O₂ scavenging performance at 10 wt %, (e.g., H₂O₂ yield of less than 1%) is superior compared with that of the 5 wt % and 20 wt % loading.

To evaluate the effect of the Ta—TiOₓ scavengers (10 wt %, Ta/Ti ratio of 6:4) on the durability of the catalyst, Fe—N—C with and without the Ta—TiOₓ/KB was subjected to a continuous voltammetry cycling process for 10,000 cycles between 0.6 and 1.0 V with a scan rate of 20 mV/s in an O₂-saturated 0.5 M H₂SO₄ solution. As shown in FIG. 8B, the ORR performance of Fe—N—C without the Ta—TiOₓ/KB showed the catalyst activity remarkably decayed after cycling, with the half-wave potential shifting by 40 mV to a more negative potential value compared to that of the pristine Fe—N—C catalysts. Additionally, as shown in FIG. 8E, there was a 3.8% H₂O₂ yield at 0.7 V after cycling the Fe—N—C catalyst without the Ta—TiOₓ/KB, corresponding to a 2.4-fold increase compared to the initial H₂O₂ yield value. The abnormally high H₂O₂ yield after cycling can be attributed to the degradation of the Fe—N₄ active sites, in which the oxidation of carbon to oxygen surface groups can induce H₂O₂ formation in subsequent cycles. In comparison, the Fe—N—C catalyst with the Ta—TiOₓ scavengers featured good durability over the 10,000 cycles with a much smaller activity loss of around 18 mV in the half-wave potential shift, as shown in FIG. 8C. The H₂O₂ yield also remained around 1.67% at 0.7 V, as shown in FIG. 8F, which is much lower than the value for the Fe—N—C catalyst without Ta—TiOₓ. These cycling tests demonstrate the ability of the Ta—TiOₓ scavengers to remove the generated H₂O₂ and radicals in a rapid and continuous manner.

To further confirm the performance of the scavengers, an accelerated durability test (ADT) was conducted on a PEM fuel cell. A catalyst ink incorporating the radical scavengers was used for the membrane electrode assembly (MEA) of the PEM fuel cell. To fabricate the MEA catalyst ink, 30 mg of the Fe—N—C catalyst containing 8 wt % of the Ta—TiOₓ/KB radical scavengers was wetted with 360 μL of water (360 mg) and 458 μL of iso-propanol (360 mg). 330 mg of 5 wt % Nafion™ binder solution was subsequently added to the wetted catalyst suspension and sonicated for 30 minutes. The MEA was made by brush-painting the catalyst ink onto a membrane with an area of 5.0 cm². The cathode catalyst loading was maintained at 6.0 mg/cm. The anode catalyst loading was 0.2 mg_{Pt}/cm of Pt/C, which was coated on a carbon paper that acted as a gas-diffusion layer. Another gas-diffusion layer was placed on the cathode side of the membrane while assembling the MEA. Fuel cell polarization curves were recorded at 100% relative humidity (R_{H}) and 80° C. under 1.0 bar H₂/O₂. The PEM fuel cell durability tests were carried out using a voltage-step protocol comprised of 20 cycles of holding potential at 0.85 V for 5 minutes and 0.40 V for 55 min (duration=20 hours) under 1.0 bar H₂/air at a cell temperature of 80° C.

FIGS. 9A-9B show the cell voltage and power density polarization plots of the cells operated with and without the scavengers at different current densities. After the durability test, the fuel cell with the Ta—TiOₓ/KB scavengers maintained a current density of 0.63 A/cm² at 0.6 V and achieved a peak power of 700 mW/cm², which outperforms the cell fabricated without scavengers (0.39 A/cm² at 0.6 V and 370 mW/cm²). FIG. 9C compares the current density of the cells with and without the Ta—TiOₓ/KB scavengers at voltages of 0.8 and 0.9 V_{iR-free}. The cell without the Ta—TiOₓ scavengers features a significant current density decay after the durability test of 33% at 0.9 V_{iR-free} and 52% at 0.8 V_{iR-free}, while the cell with the Ta—TiOₓ/KB scavengers presents only a negligible decay of 3% at 0.9 V_{iR-free} and 14% at 0.8 V_{iR-free}. These findings show the Ta—TiOₓ scavengers play a prominent role in the improvement of the PGM-free cathode durability.

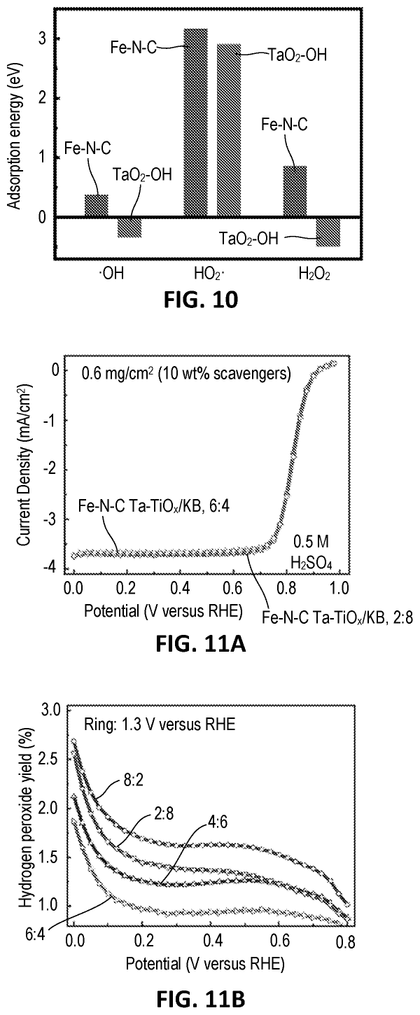

To elucidate the mechanisms of radical scavenging on the Ta—TiOₓ nanoparticles, density functional theory (DFT) calculations were employed to investigate the interactions of ^{·}OH, HO₂^{·} and H₂O₂ with different oxide surfaces and identify the feasible reaction routes with enhanced scavenging capability. The adsorption energies of H₂O₂ and related radicals (^{·}OH and HO₂^{·}) were compared on the most stable surfaces of Fe—N—C, TiO₂, Ta₂O₅, and TaO₂ to evaluate their abilities to capture H₂O₂ and related radicals. The computed surface Pourbaix diagram showed that under reaction conditions, the TaO₂ (110) surface is covered with 1 ML OH*. As shown in FIG. 10, the TaO₂—OH (110) surface has stronger adsorption energies than Fe—N—C for H₂O₂, ^{·}OH and HO₂^{·}, suggesting that it is more competitive at capturing H₂O₂ and related radicals, which can help impede their attack to the Fe—N—C active sites.

To further understand the catalytic mechanisms of H₂O₂ decomposition on the TaO₂—OH surface, the energy profiles for all possible pathways were computed for H₂O₂/radicals decomposition, including direct dehydrogenation, O*-assisted pathway, OH*-assisted pathway, and O*+O*-recombination. It was found that the OH*- and O*-assisted pathways provided the most energetically efficient route to scavenge radicals and produce H₂O and O₂. Both reaction pathways start with a homolytic O—O bond scission step, in which two OH* species are the initial intermediates generated during H₂O₂ decomposition. In the O*-assisted pathway, OH* species were further disproportionated to form O* and H₂O*, whereas OH*-assisted pathway can bypass this step to directly form OOH* and H₂O*. Both pathways contain a subsequent rapid H-transfer step for the completion of the disproportionation reaction routes. It is worth noting that the first step of H₂O₂ decomposition on the TaO₂—OH surface shows a relatively moderate energy, thus making it a promising candidate for Pt-like H₂O₂ and radical scavenging.

### Additional Examples of the Disclosed Technology

In view of the above-described implementations of the disclosed subject matter, this application discloses the additional examples in the clauses enumerated below. It should be noted that one feature of a clause in isolation, or more than one feature of the clause taken in combination, and, optionally, in combination with one or more features of one or more further clauses are further examples also falling within the disclosure of this application.

Clause 1. A catalytic structure comprising:
a catalyst; and
one or more radical scavengers, each radical scavenger comprising one or more nanoparticles, each nanoparticle being formed as an oxide or oxynitride and comprising at least one metal selected from the group consisting of titanium (Ti), zirconium (Zr), hafnium (Hf), rutherfordium (Rf), vanadium (V), niobium (Nb), tantalum (Ta), and dubnium (Db).
   Clause 2. The catalytic structure of any clause or example herein, in particular, Clause 1, wherein each radical scavenger comprises a substrate, the one or more nanoparticles being supported on the substrate.
   Clause 3. The catalytic structure of any clause or example herein, in particular, Clause 2, wherein each substrate comprises carbon.
   Clause 4. The catalytic structure of any clause or example herein, in particular, any one of Clauses 1-3, wherein the one or more nanoparticles comprise at least 50 wt % of the respective radical scavenger.
   Clause 5. The catalytic structure any clause or example herein, in particular, any one of Clauses 1-4, wherein the one or more nanoparticles is approximately 66 wt % of the respective radical scavenger.
   Clause 6. The catalytic structure of any clause or example herein, in particular, Clause 2, wherein each substrate comprises silica.
   Clause 7. The catalytic structure of any clause or example herein, in particular, any one of Clauses 1-6, wherein a maximum cross-sectional dimension of each nanoparticle is approximately 5 nm.
   Clause 8. The catalytic structure of any clause or example herein, in particular, any one of Clauses 1-7, wherein each nanoparticle has a maximum cross-sectional dimension in a range of 1-10 nm, inclusive.
   Clause 9. The catalytic structure of any clause or example herein, in particular, any one of Clauses 1-8, wherein each nanoparticle is a tantalum/titanium oxide nanoparticle.
   Clause 10. The catalytic structure of any clause or example herein, in particular, Clause 9, wherein each nanoparticle comprises a rutile tantalum oxide phase.
   Clause 11. The catalytic structure of any clause or example herein, in particular, any one of Clauses 9-10, wherein an atomic ratio of tantalum (Ta) to titanium (Ti) is in a range of 4:6 to 8:2.
   Clause 12. The catalytic structure of any clause or example herein, in particular, any one of Clauses 9-11, wherein an atomic ratio of tantalum (Ta) to titanium (Ti) is approximately 6:4.
   Clause 13. The catalytic structure of any clause or example herein, in particular, any one of Clauses 1-12, wherein the one or more radical scavengers comprises 5-20 wt % of the catalytic structure.
   Clause 14. The catalytic structure of any clause or example herein, in particular, any one of Clauses 1-13, wherein the one or more radical scavengers is approximately 10 wt % of the catalytic structure.
   Clause 15. The catalytic structure of any clause or example herein, in particular, any one of Clauses 1-14, wherein the one or more radical scavengers are disposed on or intermixed with the catalyst.
   Clause 16. The catalytic structure of any clause or example herein, in particular, any one of Clauses 1-15, wherein each nanoparticle is constructed to decompose hydrogen peroxide (H₂O₂) into water (H₂O) and oxygen (O₂) via a disproportionation reaction.
   Clause 17. The catalytic structure of any clause or example herein, in particular, any one of Clauses 1-16, wherein the catalyst is constructed for use in an oxygen reduction reaction.
   Clause 18. The catalytic structure of any clause or example herein, in particular, any one of Clauses 1-17, wherein the catalyst is a platinum-group metal (PGM) free catalyst.
   Clause 19. The catalytic structure of any clause or example herein, in particular, any one of Clauses 1-18, wherein the catalyst comprises carbon co-doped with a transition metal and nitrogen (N).
   Clause 20. The catalytic structure of any clause or example herein, in particular, any one of Clauses 1-19, wherein the catalyst comprises carbon co-doped with (i) nitrogen (N) and (ii) cobalt (Co), manganese (Mn), iron (Fe), tin (Sn), nickel (Ni), copper (Cu), or zinc (Zn).
   Clause 21. The catalytic structure of any clause or example herein, in particular, any one of Clauses 1-17, wherein the catalyst comprises one or more platinum-group metals.
   Clause 22. The catalytic structure of any clause or example herein, in particular, any one of Clauses 1-21, wherein each nanoparticle is formed as an oxide or oxynitride and comprises at least two metals selected from the group consisting of Ti, Zr, Hf, Rf, V, Nb, Ta, and Db.
   Clause 23. A fuel cell comprising:
a proton-exchange membrane;
at least one catalyst electrode disposed adjacent to the proton-exchange membrane; and
the catalytic structure of any one clause or example herein, in particular, any one of Clauses 1-22,
wherein the catalytic structure is formed as part of the proton-exchange membrane, formed as part of the at least one catalyst electrode, disposed on a surface of the at least one catalyst electrode, or disposed on a surface of the proton-exchange membrane.
   Clause 24. A radical scavenger for use with a catalyst, the radical scavenger comprising:
one or more nanoparticles, each nanoparticle being formed as an oxide or oxynitride and comprising at least one metal selected from the group consisting of titanium (Ti), zirconium (Zr), hafnium (Hf), rutherfordium (Rf), vanadium (V), niobium (Nb), tantalum (Ta), and dubnium (Db).
   Clause 25. The radical scavenger of any clause or example herein, in particular, Clause 24, further comprising a substrate, the one or more nanoparticles being supported on the substrate.
   Clause 26. The radical scavenger of any clause or example herein, in particular, Clause 25, wherein the substrate comprises carbon.
   Clause 27. The radical scavenger of any clause or example herein, in particular, any one of Clauses 24-26, wherein the one or more nanoparticles comprise at least 50 wt % of the radical scavenger.
   Clause 28. The radical scavenger of any clause or example herein, in particular, any one of Clauses 24-27, wherein the one or more nanoparticles is approximately 66 wt % of the radical scavenger.
   Clause 29. The radical scavenger of any clause or example herein, in particular, Clause 25, wherein the substrate comprises silica.
   Clause 30. The radical scavenger of any clause or example herein, in particular, any one of Clauses 24-29, wherein a maximum cross-sectional dimension of each nanoparticle is approximately 5 nm.
   Clause 31. The radical scavenger of any clause or example herein, in particular, any one of Clauses 24-30, wherein each nanoparticle has a maximum cross-sectional dimension in a range of 1-10 nm, inclusive.
   Clause 32. The radical scavenger of any clause or example herein, in particular, any one of Clauses 24-31, wherein each nanoparticle is a tantalum/titanium oxide nanoparticle.
   Clause 33. The radical scavenger of any clause or example herein, in particular, Clause 32, wherein each nanoparticle comprises a rutile tantalum oxide phase.
   Clause 34. The radical scavenger of any clause or example herein, in particular, any one of Clauses 32-33, wherein an atomic ratio of tantalum (Ta) to titanium (Ti) is in a range of 4:6 to 8:2.
   Clause 35. The radical scavenger of any clause or example herein, in particular, any one of Clauses 32-34, wherein an atomic ratio of tantalum (Ta) to titanium (Ti) is approximately 6:4.
   Clause 36. The radical scavenger of any clause or example herein, in particular, any one of Clauses 24-35, wherein each nanoparticle is constructed to decompose hydrogen peroxide (H₂O₂) into water (H₂O) and oxygen (O₂) via a disproportionation reaction.
   Clause 37. The radical scavenger of any clause or example herein, in particular, any one of Clauses 24-36, wherein each nanoparticle is formed as an oxide or oxynitride and comprises at least two metals selected from the group consisting of Ti, Zr, Hf, Rf, V, Nb, Ta, and Db.
   Clause 38. A method comprising:
performing an oxygen reduction reaction in the presence of a catalyst; and
decomposing, via one or more radical scavengers, hydrogen peroxide (H₂O₂) into water (H₂O) and oxygen (O₂) via a disproportionation reaction,
wherein each radical scavenger comprises one or more nanoparticles, each nanoparticle being formed as an oxide or oxynitride and comprises at least one metal selected from the group consisting of titanium (Ti), zirconium (Zr), hafnium (Hf), rutherfordium (Rf), vanadium (V), niobium (Nb), tantalum (Ta), and dubnium (Db).
   Clause 39. The method of any clause or example herein, in particular, Clause 38, wherein the decomposing is such that a yield of hydrogen peroxide is less than or equal to 2%.
   Clause 40. The method of any clause or example herein, in particular, any one of Clauses 38-39, wherein the oxygen reduction reaction is at least part of operation of a fuel cell.
   Clause 41. The method of any clause or example herein, in particular, any one of Clauses 38-40, wherein each radical scavenger comprises a substrate, the one or more nanoparticles being supported on the substrate.
   Clause 42. The method of any clause or example herein, in particular, Clause 41, wherein each substrate comprises carbon.
   Clause 43. The method of any clause or example herein, in particular, any one of Clauses 38-42, wherein the one or more nanoparticles comprise at least 50 wt % of the respective radical scavenger.
   Clause 44. The method of any clause or example herein, in particular, any one of Clauses 38-43, wherein the one or more nanoparticles is approximately 66 wt % of the respective radical scavenger.
   Clause 45. The method of any clause or example herein, in particular, Clause 41, wherein each substrate comprises silica.
   Clause 46. The method of any clause or example herein, in particular, any one of Clauses 38-45, wherein a maximum cross-sectional dimension of each nanoparticle is ˜5 nm.
   Clause 47. The method of any clause or example herein, in particular, any one of Clauses 38-46, wherein each nanoparticle has a maximum cross-sectional dimension in a range of 1-10 nm, inclusive.
   Clause 48. The method of any clause or example herein, in particular, any one of Clauses 38-47, wherein each nanoparticle is a tantalum/titanium oxide nanoparticle.
   Clause 49. The method of any clause or example herein, in particular, Clause 48, wherein each nanoparticle comprises a rutile tantalum oxide phase.
   Clause 50. The method of any clause or example herein, in particular, any one of Clauses 48-49, wherein an atomic ratio of tantalum (Ta) to titanium (Ti) is in a range of 4:6 to 8:2.
   Clause 51. The method of any clause or example herein, in particular, any one of Clauses 48-50, wherein an atomic ratio of tantalum (Ta) to titanium (Ti) is approximately 6:4.
   Clause 52. The method of any clause or example herein, in particular, any one of Clauses 38-51, wherein the one or more radical scavengers are disposed on or intermixed with the catalyst.
   Clause 53. The method of any clause or example herein, in particular, any one of Clauses 38-52, wherein the catalyst is a platinum-group metal (PGM) free catalyst.
   Clause 54. The method of any clause or example herein, in particular, any one of Clauses 38-53, wherein the catalyst comprises carbon co-doped with a transition metal and nitrogen (N).
   Clause 55. The method of any clause or example herein, in particular, any one of Clauses 38-54, wherein the catalyst comprises carbon co-doped with (i) nitrogen (N) and (ii) cobalt (Co), manganese (Mn), iron (Fe), tin (Sn), nickel (Ni), copper (Cu), or zinc (Zn).
   Clause 56. The method of any clause or example herein, in particular, any one of Clauses 38-52, wherein the catalyst comprises one or more platinum-group metals.
   Clause 57. The method of any clause or example herein, in particular, any one of Clauses 38-56, each nanoparticle is formed as an oxide or oxynitride and comprises at least two metals selected from the group consisting of Ti, Zr, Hf, Rf, V, Nb, Ta, and Db.
   Clause 58. A method comprising:
(a) providing one or more precursors on a substrate; and
(b) subjecting the one or more precursors to a thermal shock so as to convert the one or more precursors into one or more nanoparticles, each nanoparticles being formed as an oxide or oxynitride and comprising at least one metal selected from the group consisting of titanium (Ti), zirconium (Zr), hafnium (Hf), rutherfordium (Rf), vanadium (V), niobium (Nb), tantalum (Ta), and dubnium (Db),
wherein the thermal shock comprises exposure to a peak temperature of at least 750 K for a duration less than or equal to 60 seconds, and the one or more nanoparticles form a radical scavenger for use with a catalyst.
   Clause 59. The method of any clause or example herein, in particular, Clause 58, wherein the duration of the thermal shock is in a range of 10 milliseconds to 10 seconds, inclusive.
   Clause 60. The method of any clause or example herein, in particular, any one of Clauses 58-59, wherein the duration of the thermal shock is less than or equal to 100 milliseconds.
   Clause 61. The method of any clause or example herein, in particular, any one of Clauses 58-60, wherein the peak temperature is greater than or equal 1200 K.
   Clause 62. The method of any clause or example herein, in particular, any one of Clauses 58-61, wherein the peak temperature is in a range of 1500-3000 K, inclusive.
   Clause 63. The method of any clause or example herein, in particular, any one of Clauses 58-62, wherein the subjecting to the thermal shock comprises, before the duration, heating to the peak temperature at a heating rate of at least 10³ K/s.
   Clause 64. The method of any clause or example herein, in particular, any one of Clauses 58-63, wherein the subjecting to the thermal shock comprises, before the duration, heating to the peak temperature at a heating rate in a range of 10³-10⁵ K/s, inclusive.
   Clause 65. The method of any clause or example herein, in particular, any one of Clauses 58-64, wherein the subjecting to the thermal shock comprises, after the duration, cooling from the peak temperature at a cooling rate of at least 10³ K/s.
   Clause 66. The method of any clause or example herein, in particular, any one of Clauses 58-65, wherein the subjecting to the thermal shock comprises, after the duration, cooling from the peak temperature at a cooling rate in a range of 10³-10⁵ K/s, inclusive.
   Clause 67. The method of any clause or example herein, in particular, any one of Clauses 58-66, wherein the providing of (a) comprises:
(a1) mixing the one or more precursors with the substrate to form a slurry;
(a2) drying the slurry to form a composite solid; and
(a3) crushing the composite solid to form a powder.
   Clause 68. The method of any clause or example herein, in particular, Clause 67, wherein the drying of (a2) comprises freeze-drying or critical point drying.
   Clause 69. The method of any clause or example herein, in particular, any one of Clauses 58-68, further comprising, after (b):
(c) combining the catalyst and the radical scavenger to form a catalytic structure.
   Clause 70. The method of any clause or example herein, in particular, Clause 69, further comprising, after (c):
(d1) coating the catalytic structure on a proton exchange membrane or a catalyst electrode layer of a fuel cell;
(d2) forming at least part of a proton exchange membrane or a catalyst electrode layer of a fuel cell using the catalytic structure; or
both (d1) and (d2).
   Clause 71. The method of any clause or example herein, in particular, any one of Clauses 58-70, wherein the catalyst is a platinum-group metal (PGM) free catalyst.
   Clause 72. The method of any clause or example herein, in particular, Clause 71, wherein the catalyst comprises carbon co-doped with a transition metal and nitrogen (N).
   Clause 73. The method of any clause or example herein, in particular, any one of Clauses 71-72, wherein the catalyst comprises carbon co-doped with (i) nitrogen (N) and (ii) cobalt (Co), manganese (Mn), iron (Fe), tin (Sn), nickel (Ni), copper (Cu), or zinc (Zn).
   Clause 74. The method of any clause or example herein, in particular, any one of Clauses 58-70, wherein the catalyst comprises one or more platinum-group metals.
   Clause 75. The method of any clause or example herein, in particular, any one of Clauses 58-74, wherein the substrate comprises carbon or silica.
   Clause 76. The method of any clause or example herein, in particular, any one of Clauses 58-75, wherein each nanoparticle has a maximum cross-sectional dimension in a range of 1-10 nm, inclusive.
   Clause 77. The method of any clause or example herein, in particular, any one of Clauses 58-76, wherein each nanoparticle is a tantalum/titanium oxide nanoparticle, and the one or more precursors comprises titanium isopropoxide and tantalum ethoxide.
   Clause 78. The method of any clause or example herein, in particular, any one of Clauses 58-77, wherein each nanoparticle comprises a rutile tantalum oxide phase.
   Clause 79. The method of any clause or example herein, in particular, any one of Clauses 58-78, wherein each nanoparticle is a tantalum/titanium oxide nanoparticle having an atomic ratio of tantalum (Ta) to titanium (Ti) in a range of 4:6 to 8:2.
   Clause 80. The method of any clause or example herein, in particular, any one of Clauses 58-79, wherein each nanoparticle is a tantalum/titanium oxide nanoparticle having an atomic ratio of tantalum (Ta) to titanium (Ti) of approximately 6:4.
   Clause 81. The method of any clause or example herein, in particular, any one of Clauses 58-80, wherein the thermal shock of (b) comprises heating via a Joule heating element, a microwave heating source, a laser, an electron beam device, a spark discharge device, or any combination of the foregoing.
   Clause 82. The method of any clause or example herein, in particular, any one of Clauses 58-81, wherein each nanoparticle is formed as an oxide or oxynitride and comprises at least two metals selected from the group consisting of Ti, Zr, Hf, Rf, V, Nb, Ta, and Db.

### CONCLUSION

Any of the features illustrated or described herein, for example, with respect to FIGS. 1A-13B and Clauses 1-82, can be combined with any other feature illustrated or described herein, for example, with respect to FIGS. 1A-13B and Clauses 1-82 to provide materials, systems, devices, structures, methods, and/or embodiments not otherwise illustrated or specifically described herein. All features described herein are independent of one another and, except where structurally impossible, can be used in combination with any other feature described herein. In view of the many possible embodiments to which the principles of the disclosed technology may be applied, it should be recognized that the illustrated embodiments are only examples and should not be taken as limiting the scope of the disclosed technology. Rather, the scope is defined by the following claims. We therefore claim all that comes within the scope and spirit of these claims.

1. A catalytic structure comprising:
a catalyst; and
one or more radical scavengers, each radical scavenger comprising one or more nanoparticles, each nanoparticle being formed as an oxide or oxynitride and comprising at least one metal selected from the group consisting of titanium (Ti), zirconium (Zr), hafnium (Hf), rutherfordium (Rf), vanadium (V), niobium (Nb), tantalum (Ta), and dubnium (Db).

2-6. (canceled)

7. The catalytic structure of claim 1, wherein each nanoparticle comprises at least two metals selected from the group consisting of Ti, Zr, Hf, Rf, V, Nb, Ta, and Db.

8. (canceled)

9. The catalytic structure of claim 1, wherein each nanoparticle is a tantalum/titanium oxide nanoparticle.

10. The catalytic structure of claim 9, wherein each nanoparticle comprises a rutile tantalum oxide phase.

11. The catalytic structure of claim 9, wherein an atomic ratio of tantalum (Ta) to titanium (Ti) is in a range of 4:6 to 8:2.

12-17. (canceled)

18. The catalytic structure of claim 1, wherein the catalyst is a platinum-group metal (PGM) free catalyst.

19-35. (canceled)

36. A method comprising:
performing an oxygen reduction reaction in the presence of a catalyst; and
decomposing, via one or more radical scavengers, hydrogen peroxide (H₂O₂) into water (H₂O) and oxygen (O₂) via a disproportionation reaction,
wherein each radical scavenger comprises one or more nanoparticles, and
each nanoparticle is formed as an oxide or oxynitride and comprises at least one metal selected from the group consisting of titanium (Ti), zirconium (Zr), hafnium (Hf), rutherfordium (Rf), vanadium (V), niobium (Nb), tantalum (Ta), and dubnium (Db).

37. The method of claim 36, wherein the decomposing is such that a yield of hydrogen peroxide is less than or equal to 2%.

38. The method of claim 36, wherein the oxygen reduction reaction is at least part of operation of a fuel cell.

39-43. (canceled)

44. The method of claim 36, wherein each nanoparticle comprises at least two metals selected from the group consisting of Ti, Zr, Hf, Rf, V, Nb, Ta, and Db.

45. (canceled)

46. The method of claim 36, wherein each nanoparticle is a tantalum/titanium oxide nanoparticle.

47-50. (canceled)

51. The method of claim 36, wherein the catalyst is a platinum-group metal (PGM) free catalyst.

52-54. (canceled)

55. A method comprising:
(a) providing one or more precursors on a substrate; and
(b) subjecting the one or more precursors to a thermal shock so as to convert the one or more precursors into one or more nanoparticles, each nanoparticles being formed as an oxide or oxynitride and comprising at least one metal selected from the group consisting of titanium (Ti), zirconium (Zr), hafnium (Hf), rutherfordium (Rf), vanadium (V), niobium (Nb), tantalum (Ta), and dubnium (Db),
wherein the thermal shock comprises exposure to a peak temperature of at least 750 K for a duration less than or equal to 60 seconds, and
the one or more nanoparticles form a radical scavenger for use with a catalyst.

56. The method of claim 55, wherein the duration of the thermal shock is in a range of 10 milliseconds to 10 seconds, inclusive.

57. (canceled)

58. The method of claim 55, wherein the peak temperature is greater than or equal 1200 K.

59-65. (canceled)

66. The method of claim 55, further comprising, after (b):
(c) combining the catalyst and the radical scavenger to form a catalytic structure.

67. The method of claim 66, further comprising, after (c):
(d1) coating the catalytic structure on a proton exchange membrane or a catalyst electrode layer of a fuel cell;
(d2) forming at least part of a proton exchange membrane or a catalyst electrode layer of a fuel cell using the catalytic structure; or
(d3) both (d1) and (d2).

68. The method of claim 66, wherein the catalyst is a platinum-group metal (PGM) free catalyst.

69-73. (canceled)

74. The method of claim 55, wherein each nanoparticle is a tantalum/titanium oxide nanoparticle, and the one or more precursors comprises titanium isopropoxide and tantalum ethoxide.

75. (canceled)

76. The method of claim 55, wherein each nanoparticle is a tantalum/titanium oxide nanoparticle having an atomic ratio of tantalum (Ta) to titanium (Ti) in a range of 4:6 to 8:2.

77-79. (canceled)
